(19) United States
(12) Patent Application Publication
(10) Pub. No.: US 2017/0138312 A1
(43) Pub. Date: May 18, 2017

(54) FUEL RAIL ASSEMBLIES

(71) Applicant: ORBITAL AUSTRALIA PTY LTD, Balcatta, Western Australia (AU)

(72) Inventors: David James CALEY, City Beach (AU); Nicholas COPLIN, Merriwa (AU); Thomas GERLACH, Karrinyup (AU)

(73) Assignee: ORBITAL AUSTRALIA PTY LTD, Balcatta, Western Australia (AU)

(21) Appl. No.: 15/320,681

(22) PCT Filed: Jun. 25, 2015
(86) PCT No.: PCT/AU2015/000368

§ 371 Date: Dec. 20, 2016

(30) Foreign Application Priority Data
Jun. 25, 2014 (AU) 2014902435

(51) Int. Cl. F02M 21/02

(52) U.S. Cl. CPC F02M 21/0245; F02M 21/0275; F02M 21/0239; F02M 21/0293

(57) ABSTRACT

A fuel rail assembly for direct injection of a gaseous fuel into an internal combustion engine comprises a fuel rail defining a flow passage for receiving gaseous fuel and a delivery injector for directly injecting fuel received from the fuel rail into a combustion chamber of the engine. The delivery injector is arranged having a selectively openable delivery port for delivery of gaseous fuel into the combustion chamber when the delivery port is in an open condition. The fuel rail assembly further comprises a valve operable so as to interrupt the flow of gaseous fuel to the delivery injector for delivery into the combustion chamber. A containment zone is defined between the valve and the delivery port when the delivery port is in a closed condition, whereby the containment zone is selected so as to be a prescribed volume.

### TECHNICAL FIELD

A fuel rail assembly for use in internal combustion engines is disclosed. In one aspect, a fuel rail assembly and related method for use with a gaseous type fuel delivery system is disclosed. In a further aspect, a fuel rail assembly and related method for use with a direct injection gaseous type internal combustion engine is disclosed. In another aspect, a fuel delivery system is disclosed for direct injection of fuel into a combustion environment of an internal combustion engine.

The present application claims priority to Australian provisional application 2014902435 filed on 25 Jun. 2014, the content of which is incorporated herein by reference in its entirety.

### BACKGROUND ART

The following discussion of the background art is intended to facilitate an understanding of the present invention only. The discussion is not an acknowledgement or admission that any of the material referred to is or was part of the common general knowledge as at the priority date of the application.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

There are numerous potential advantages in using gaseous fuels, such as for example, compressed natural gas (CNG), hydrogen (H₂) and liquefied petroleum gas (LPG), in engines in place of the more commonly used liquid fuels. For example, it is well appreciated that the undesirable exhaust emissions from an engine using a gaseous fuel can be lower than for a comparable engine using liquid fuel. Further, at the present time, the use of certain gaseous fuels can translate into a significant cost saving for the user due to the per litre cost thereof as compared to the per litre cost of the commonly used liquid fuels. Gaseous fuels are injected into diesel and spark ignited engines to achieve these advantages.

The Applicant has developed certain spark ignition, direct injection two stroke and four stroke cycle internal combustion engine technologies as, for example, described in U.S. Pat. No. 4,934,329, the contents of which are hereby incorporated by reference. The term “direct injection” refers to the use of fuel injectors for injecting fuel directly into the combustion chambers of internal combustion engines, both spark ignited and compression ignition diesel engines. However, the operating environment for a spark ignition direct injection engine is significantly different to that of a diesel engine. For example, modern spark ignition engines typically operate at significantly higher engine speeds than for corresponding diesel engines. Spark ignition engines therefore provide a more demanding environment for a direct injection fuel system and its associated control system than for diesel engines.

The Applicant's internal combustion engine technologies primarily use liquid fuel and may be applied to engines using gaseous fuels as well. For example, the Applicant's U.S. Pat. No. 5,941,210, the contents of which are hereby incorporated by reference, discloses a gaseous fuel direct injection fuel system for a spark ignition internal combustion engine, preferably being a two stroke engine. The fuel injection system initiates direct injection of gaseous fuel after closing of the inlet port and injection is completed before the compression stroke of the engine is substantially completed.

Gaseous fuel could, alternatively and as is more conventionally the case, be injected into the inlet manifold or inlet port of a reciprocating engine. Such injection displaces air resulting in reduced trapped air and reduced maximum engine torque (in the case of hydrogen gas injection, there can be up to 30% loss in maximum engine torque due to displacement of intake air, and in the case of CNG this can be up to 10%). Direct injection of gaseous fuel into an engine cylinder after inlet port closure or during the compression stroke avoids such displacement of air but imposes strict timing limitations on the injection event. For a typical automotive four stroke engine, the fuel for full load operation should be injected in ≦4.0 msec to avoid displacement of air at high engine speeds. The fuel injection system must also provide controlled fuel metering at idle and low load operating conditions. This dynamic range of operation is beyond the capability of typical solenoid operated metering valves. Developments to increase responsiveness of the fuel injection system and the operating range of the injector, such as for example variable flow via variable valve lift, add cost and complexity to the injector.

However, some disadvantages of direct injection gaseous fuel delivery systems have been identified. Residual gas in a gaseous fuel system remains substantially at pressure when the system is shutdown. Even small leakages through any of the injectors can result in a number of undesireable performance problems with the engine, such as for example: (a) unreliable starting due to fuel accumulated or collected in the cylinder or manifold during shutdown prior to start, (b) high emissions in the drive cycle due to unburnt and non-catalysed fuel that has accumulated or collected in one or more cylinders (during shutdown) prior to ignition, and (c) failed vapour emissions testing due to leakage.

For the case of direct injection CNG gaseous fuel systems, the effect of leakage through the fuel injectors is different to leakage from that experienced with liquid fuel injectors because gaseous fuel delivery systems maintain pressure in the fuel rail when the system is shutdown. In contrast, a gasoline fuel delivery system remains at a relatively low pressure after the fuel pump is shutdown so any leakage through the injectors is greatly reduced. Thus, known approaches for minimising fuel leakages for the case of liquid fuel delivery systems are not directly applicable for direct injection gaseous fuel delivery systems.

It is therefore against this background that, in at least one aspect, an improved fuel rail assembly for use with direct injection gaseous fuel delivery systems has been developed.

### SUMMARY OF THE INVENTION

It will be appreciated that the term ‘direct injection’ used herein refers to delivery of fuel directly into the combustion chambers of internal combustion engines, typically by way of fuel injectors. Furthermore, the term ‘gaseous fuels’ as used herein refers to compressed gas fuels such as compressed natural gas (CNG) and hydrogen (H₂), and liquefied gaseous fuels such as liquefied petroleum gas (LPG) and liquefied natural gas (LNG). However, the skilled reader will appreciate that other appropriate gaseous fuels may also be used with various embodiments of the principal aspects of the invention described below, such as for example, natural gas, propane, methane, synthetic gas, landfill gas, coal gas, biogas from agricultural anaerobic digesters, or any other gaseous fuel.

According to a first principal aspect of the present invention, there is provided a fuel rail assembly for direct injection of a gaseous fuel into an internal combustion engine, the fuel rail assembly comprising:

a fuel rail defining a flow passage for receiving gaseous fuel;

a delivery injector for directly injecting fuel received from the fuel rail into a combustion chamber of the engine, the delivery injector having a selectively openable delivery port for delivery of gaseous fuel into the combustion chamber when the delivery port is in an open condition; and

a valve operable so as to interrupt the flow of gaseous fuel to the delivery injector for delivery into the combustion chamber;

wherein a containment zone is defined between the valve and the delivery port when the delivery port is in a closed condition, the containment zone being selected to be a prescribed volume.

According to a second principal aspect of the present invention, there is provided a fuel rail assembly for direct injection of a gaseous fuel into an internal combustion engine, the fuel rail assembly comprising:

a fuel rail defining a flow passage for receiving gaseous fuel;

a delivery injector for directly injecting fuel received from the fuel rail into a combustion chamber of the engine, the delivery injector having a selectively openable delivery port for delivery of gaseous fuel into the combustion chamber when the delivery port is in an open condition;

a valve operable to interrupt flow of gaseous fuel along the flow passage to the delivery injector for delivery into the combustion chamber;

wherein a containment zone is defined between the valve and the delivery port when the delivery port is in a closed condition, the containment zone being selected to be a prescribed volume.

Embodiments of the above described principal aspects, and those described throughout this specification, may find advantage in seeking to resolve performance problems which have been known to occur for internal combustion engines when configured for using gaseous fuels. The inventors have discovered that isolating a containment zone of a prescribed volume has the advantage of, at least in part, managing any potential leakage of gaseous fuel, which might be resident within the fuel rail assembly at engine shutdown, into one or more combustion chambers of the engine. Any such leakage, if realised, can be managed so that leaked quantities are within prescribed limits known or considered to be acceptable. In this manner, prescription of the volumetric capacity of the containment zone serves to provide an isolated region having a volume designed to accommodate a known quantity of gaseous fuel which is below acceptable levels if it were to leak into a respective or corresponding combustion chambers (and/or surrounding environs).

The prescribed volume of gaseous fuel permissible for leakage may vary according to parameters or specifications deemed acceptable for the engine. The parameters or specifications may accept a tolerable amount of leakage, and the prescribed volume of the containment zone is set according to the maximum amount deemed tolerable. The tolerable amount may be determined according to various design parameters to which regard may be had during design of the fuel rail assembly, including, for example, the extent of leakage which may be tolerable without adversely affecting performance requirements for the engine at start-up, and/or the extent of leakage which is tolerable without adversely affecting prescribed environmental emission standards for operation of the engine.

As noted above, drivers for the volumetric capacity of the prescribed volume can include limits prescribed by relevant legislation in each foreign territory. In such cases, the following limits could for example inform the design and configuration of the volumetric capacity of the prescribed volume: in Europe, for example, emissions requirements demand that gas leakages cannot exceed around 2 g propane or equivalent over a 24 hour period; in the United States, a number of states demand that emission levels cannot exceed 2 g propane or equivalent over a 72 hour period. The skilled reader will understand that 2 g propane is approximately equivalent to 2.18 g of methane based on the number of carbon atoms.

Embodiments of the first and second principal aspects of the present invention described above, and those which follow, may incorporate any of the following described features.

It will be understood that the term ‘emissions’ as referenced and/or used herein, is a reference to, in a general context, emissions of organic compounds composed of hydrogen and carbon, such as, for example, hydrocarbons, which are the substantive components of petroleum, natural gas, coal, and bitumens.

In one embodiment, the containment zone is configured so as to reduce or minimise the quantity of gaseous fuel which could escape or leak into the ambient environment and/or elsewhere in the fuel rail assembly (such as for example, one or more combustion chambers of the internal combustion engine) which would otherwise result in unwanted or unacceptable engine emissions (as may be measured, for example, by reference to prescribed environment emission standards for operation of the engine as noted above).

In another embodiment, the prescribed volume of the containment zone is configured so as to accommodate a known quantity of gaseous fuel which is substantially below acceptable emissions levels.

In a further embodiment, the containment zone is configured so as to assist in the management of potential leakage of gaseous fuel which might be resident in the fuel rail assembly at, near, or following shutdown of the internal combustion engine.

In another embodiment, the prescribed volume of the containment zone is configured so as to accommodate a known quantity of gaseous fuel which is substantially below acceptable emissions levels at, near, or following engine shutdown.

In a further embodiment, the prescribed volume of the containment zone is configured so as to account for one or more alternate sources of emissions which might emanate from other regions of the internal combustion engine and/or associated vehicle, the prescribed volume of the containment zone being prescribed such that the cumulative effect of any leakage of fuel resident in the containment zone and any emissions which might emanate from the or each alternate sources would fall below acceptable emissions limits as might be prescribed either by way of legislative standards and/or industry regulations.

It will be appreciated that reference herein to an ‘associated vehicle’ is to be understood as a reference to a machine, means of transport, motor vehicle, automobile or like conveyance/transport device which embodies an embodiment of the fuel rail assembly, fuel delivery system, fuel system, or internal combustion engine described herein.

In another embodiment, the containment zone comprises a volumetric capacity configured such that gaseous fuel confined therein is substantially less than a known emissions limit if or when combined with emissions from one or more alternate emissions sources which might be associated with the internal combustion engine and/or associated vehicle.

In a further embodiment, the containment zone comprises a volumetric capacity configured such that a difference between the gaseous fuel confined therein and a known emissions limit substantially accounts for known alternate emissions sources.

In another embodiment, the containment zone comprises a volumetric capacity configured such that a difference between the gaseous fuel confined therein and a predetermined limit accounts for substantially all known alternate emissions sources associated with the internal combustion engine and/or associated vehicle, wherein the predetermined limit is substantially less than a known emissions limit as might be prescribed by way of legislative and/or industrial regulations.

In some embodiments, the delivery injector is of the outwardly opening poppet-type which is substantially self-sealing by virtue of combustion gases acting when the injector is closed; however, other configurations may be employed including, for example, an inwardly opening poppet-type arrangement.

In other embodiments, the delivery injector comprises a delivery port and a valve for opening and closing the delivery port. The valve is of an outwardly opening poppet-type having a needle stem and a valve head at one end of the stem. The valve head cooperates with a delivery port to cause opening and closing thereof.

In one embodiment, the valve is associated with the fuel rail so as to control fuel flow along the flow passage to the delivery injector. The valve may be associated with the fuel rail in any appropriate way. In one arrangement, the valve may be located at or near an inlet end of the fuel rail. In another arrangement, for example, the valve may be located upstream of an inlet end of the fuel rail. In yet another arrangement, for example, the valve may be located within the fuel rail downstream of an inlet end thereof.

In another embodiment, the valve may be associated with the delivery injector to control fuel flow from the flow passage to the delivery injector. The valve may be associated with the delivery injector in any appropriate way. In one arrangement, for example, the valve may be incorporated in a branch line extending between the fuel rail to the delivery injector. In another arrangement, for example, the valve may be associated with the delivery injector and disposed upstream of the delivery port. In other arrangements, the valve may be integrated with the delivery injector and disposed upstream of the delivery port.

In a further embodiment, for the case where the engine comprises a single-cylinder engine, the delivery injector may comprise a sole delivery injector for the engine.

In another embodiment, for the case where the engine comprises a multi-cylinder engine (which is the more likely case), the delivery injector may comprise one of a plurality of delivery injectors for the engine.

For embodiments where the valve is associated with the delivery injector, and where there is a plurality of delivery injectors, each of the plurality of delivery injectors may have a respective valve associated therewith.

The prescribed volume may correspond to the maximum amount of gaseous fuel which is deemed to be acceptable to leak through the delivery injector(s) into the combustion chamber(s) when the delivery port, or each of the delivery ports, is in the closed condition.

For embodiments where the valve is associated with the fuel rail, the containment zone may comprise the volume downstream of the valve. This downstream volume may comprise the volume within the fuel rail downstream of the valve together with the volume associated with the fuel injector, or each of the fuel injectors, upstream of the respective delivery port(s).

For embodiments where there are pluralities of delivery injectors each having a respective one of the valves, the containment zone may comprise the accumulation of a plurality of distinct volumes each corresponding to the volume between a respective one of the valves and the delivery port of the respective delivery injector.

In some embodiments, the prescribed volumetric capacity of the containment zone can be configured so as to account for one or more alternate sources of hydrocarbon emissions which might emanate from other regions of the engine and/or associated vehicle. Thus, the volumetric capacity of the containment zone may be prescribed such that the cumulative effect of any leakage of fuel trapped in the containment zone and any hydrocarbon emissions which might emanate from one or more alternate sources, would fall below acceptable emissions limits as might be prescribed either by way of legislative standards and/or industry regulations. Alternate sources of emissions within the context of the present invention could comprise any one or more of the following: various plastics and/or rubbers which might permeate or emit gaseous vapour (such as may occur from upholstery and fuel system hoses), various glues and paints which are known to contribute to hydrocarbon emissions. It will be appreciated that other components of an engine (or associated vehicle) could also be responsible for emission levels the subject of legislative and/or industrial regulations.

According to one embodiment, the containment zone comprises a volumetric capacity configured such that gaseous fuel confined therein is substantially less than a known emissions limit if or when combined with emissions from one or more alternate sources of hydrocarbon emitters. In another embodiment, the containment zone comprises a volumetric capacity configured such that gaseous fuel confined therein is substantially less than a known emissions limit if or when combined with emissions from one or more alternate emissions sources which might be associated with the internal combustion engine and/or associated vehicle.

According to another embodiment, the containment zone comprises a volumetric capacity configured such that a difference between the gaseous fuel confined therein and a known emissions limit substantially accounts for known alternate emissions sources.

According to a further embodiment, the containment zone comprises a volumetric capacity configured such that a difference between the gaseous fuel confined therein and a predetermined limit accounts for substantially all known alternate emissions sources, wherein the predetermined limit is substantially less than a known emissions limit as might be prescribed by way of legislative and/or industrial regulations. In such arrangements, the predetermined limit, at least in part, may serve as a design standard to ensure that known and identified sources of hydrocarbon emissions are accounted for when prescribing the volumetric capacity of the containment zone. In one embodiment, the predetermined limit could be set or defined as a nominated amount which is less than the known emissions limit, such as for example, a percentage of said emissions limit, or another associated variable which serves to quantify a level of tolerance. Thus, the difference between the known emissions limit and the predetermined limit could reflect a margin of tolerance ensuring that, should gaseous fuel contained in the containment zone leak through a delivery port, there will be sufficient confidence that emissions levels will be less than prescribed levels as what might be set by legislative/regulatory requirements when also considering and accounting for known alternate emissions sources.

In one embodiment, the fuel rail comprises an outlet through which fuel can exit or exhaust from the flow passage. The outlet may be provided downstream of the inlet end of the fuel rail.

In another embodiment, one or more fluid circuits may be fluidly connected to the outlet such that gaseous fuel in the flow passage in the fuel rail may flow through and into the or each fluid circuit. It will be appreciated that the outlet could readily be provided with a valve means so that quantities of gaseous fuel in the flow passage can be selectively diverted into the first fluid circuit when desired (such as, for example, by way of an electronic control unit).

In another embodiment, the flow passage may be configured so that the containment zone can be placed in fluid communication (for example, via the outlet of the fuel rail) with a first fluid circuit for releasing fuel contained in the containment zone. In this manner, the release of fuel from the containment zone may serve to reduce the gaseous pressure therein.

In one arrangement, the first fluid circuit may be arranged having any one or more of the following provided in-circuit therewith: one or more valves so as to control and/or manage the flow of fuel therethrough, one or more isolated containment volumes so that gaseous fuel pressure held in the containment zone can be moved or expanded into the or each volume, one or more carbon canister units, one or more catalytic converters, the intake region of the engine, ambient atmosphere, or one or more of the combustion chambers of the engine. It will be understood that any of the latter can be arranged in any appropriate configuration within the first fluid circuit.

In one embodiment, a flow control valve may be provided at any point in-circuit with the first fluid circuit so that the flow of gaseous fuel through or along the first fluid circuit can be controlled in a substantially selective manner (such as for example by way of an electronic control unit). The flow control valve of the first fluid circuit may be operated such that the rate of gaseous fuel passing therethrough can be selectively controlled and/or managed as required (for example, by the electronic control unit).

In one embodiment, the flow control valve of the first fluid circuit is configured so as to be capable of venting directly to atmosphere or to an appropriate means for trapping emissions (such as for example hydrocarbon emissions) for later consumption by the engine.

The first fluid circuit may be fluidly connected with a first volume provided downstream of the flow control valve of the first fluid circuit. In this manner, gaseous fuel from the flow passage of the fuel rail can be permitted to flow into the first volume when the flow control valve is open. The first volume can be provided in the form of an isolated containment volume of any desired volumetric capacity arranged separate to the fuel rail but fluidly connectable thereto by operation of the flow control valve of the first fluid circuit.

The first volume can be provided with any number of suitable sensor arrangements (such as for example pressure, temperature, and/or flow sensors) configured such that in-situ characteristics of any fuel residing in the first volume can be monitored for appropriate response (such as by way of an electronic control unit). A benefit of arrangements of this nature is that gaseous fuel pressure in the fuel rail can be reduced in a more immediate period of time when required or when favourable to engine performance. Thus, the time for transitioning between high and low operating modes can be managed in a manner appropriate.

In one embodiment, the first volume can be used to reduce the fuel pressure in the containment zone in the fuel rail when the valve (that which is provided upstream or within the flow passage so as to selectively interrupt the flow of fuel to the or each delivery injectors so as to define the containment zone) closes. Thus, the first volume can be configured operable so as to reduce the fuel pressure in the containment zone in the fuel rail when the valve operable so as to interrupt flow of the gaseous fuel to the delivery injector(s) closes. In this manner, with the valve closed, the flow control valve of the first fluid circuit can be opened allowing gaseous fuel resident or trapped in the containment zone to expand into the first volume. Once the gaseous fuel pressure of the fuel rail has been reduced, the flow control valve of the first fluid circuit can be closed so as to re-define the containment zone. Thus, it will be appreciated that the amount of gaseous fuel resident in the containment zone in the fuel rail when the valve is closed can be reduced so as to lower emissions levels should any leakage through the delivery ports occur while the engine is shutdown.

A second fluid circuit may be fluidly connected to the first fluid circuit. In some embodiments, the second fluid circuit is arranged in fluid communication with any point along the first fluid circuit upstream of the flow control valve of the first fluid circuit and downstream of the outlet of the fuel rail.

In another embodiment, the second fluid circuit may be fluidly connected to a second outlet provided in the fuel rail. In one arrangement, the second outlet is arranged relative the flow passage so that the second fluid circuit can be provided in fluid communication with the containment zone when defined.

The skilled reader will appreciate that the first and second fluid circuits can be provided in any form appropriate in the art. For example, either circuit may be arranged to comprise any number of conduit elements configured in any appropriate manner to ensure fluid communication between the components within each respective fluid circuit so as to ensure sufficient flow therethrough when desired.

In one embodiment where both the first and the second fluid circuits are present, a flow control valve may be provided in-circuit with the second fluid circuit. Thus, for the case when the flow control valve of the first fluid circuit is closed, gaseous fuel exiting through the outlet of the fuel rail may flow into the second fluid circuit. Flow of fuel along the second fluid circuit may be selectively controllable, i.e. by way of for example, the electronic control unit operating the flow control valve of the second fluid circuit. Therefore, residual gaseous fuel resident in the containment zone at the time the valve is closed can be vented from the system by way of the flow control valve of the second fluid circuit. It will be appreciated that the flow control valve of the second fluid circuit can be arranged to vent the gaseous fuel to any number of (generally relatively lower pressure) environments, such as for example, ambient atmosphere or another region of the engine, such as for example the engine's air intake and/or one or more combustion chambers.

In one arrangement, the flow control valves of the first and/or second fluid circuits could each be arranged to vent directly to atmosphere or to an appropriate means for trapping (such as for example a carbon canister) hydrocarbons (see below) for later consumption by the engine. Thus, the flow control valves of the first and/or second fluid circuits are each arranged so as to be capable of venting directly to atmosphere or to an appropriate means for trapping hydrocarbons emissions for later consumption by the engine.

In another embodiment, a second volume is fluidly connected with the second fluid circuit. In one arrangement, the second volume is fluidly connected with the second fluid circuit downstream of the flow control valve of the second fluid circuit. In this manner, the flow of gaseous fuel through the second fluid circuit can be selectively directed into the second volume. As the skilled reader will readily appreciate, this embodiment of the second fluid circuit shares similarities with that of the fluid circuit when fluidly connected with the first volume. In this regard, the second volume may also be provided in the form of an isolated containment volume of any desired volumetric capacity appropriate for the circumstance. Similarly, the second volume can be provided with any number of suitable sensor arrangements (such as for example pressure, temperature, and/or flow sensors) arranged such that in-situ characteristics of gaseous fuel residing in the second volume can be monitored for appropriate response (such as by way of an electronic control unit).

The second fluid circuit may be provided with a second flow control valve arranged in-circuit therewith. In one arrangement, the second flow control valve of the second fluid circuit may be provided in the form of a non-return valve provided in-circuit and downstream of the second volume. The second flow control valve of the second fluid circuit may be arranged so as to be controlled or managed in a similar manner as the flow control valves of the first and second fluid circuits respectively. In operation, similar to that described above, the second flow control valve of the second fluid circuit may be operated (such as by way of an electronic control unit) so as to vent gaseous fuel resident in the second volume when desired. The skilled reader will appreciate that the second flow control valve of the second fluid circuit could take the form of any appropriate valve means suitable for selective control of fluid flowing in the second fluid circuit.

In another embodiment, the second flow control valve of the second fluid circuit can be arranged so as to be fluidly connected with the engine's air intake.

In a further embodiment, the second volume within the second fluid circuit can be replaced by a means for trapping (or containing) hydrocarbons such that the trapped matter can be conveyed back for consumption by the engine (such as for example the engine air intake, one or more of the engine's combustion chambers, or to a catalytic converter unit at or around engine shutdown). Such a means for trapping hydrocarbon matter can be provided in the form of a carbon canister typically arranged for trapping hydrocarbons inherent with fuel vapour rising within or from fuel tanks and/or associated conduit hoses, or fuel vapour emanating from the fuel rail assembly/system itself. The general configuration and structure of carbon canisters is well known in the art and therefore beyond the scope of further discussion herein.

It will be appreciated that such a means for trapping hydrocarbon matter and like could be readily arranged as part of any of the aforementioned fluid circuits, or in an appropriate manner, in-circuit with the fuel rail assembly.

In one embodiment, gaseous fuel from the containment zone is delivered directly into one or more of the combustion chambers at, near, or following engine shutdown and/or start up. In some embodiments, a fuel delivery system comprising any of the embodiments of the fuel rail assembly described herein could be arranged so that gaseous fuel from the containment zone is delivered directly into one or more of the combustion chambers at, near, or following engine shutdown and/or start up. For example, gaseous fuel could be routed using one or more fluid circuits from the containment zone and delivered to one or more combustion chambers during one of the following possible stages during the piston timing cycle: during the compression stroke once the inlet valve has been opened, during the expansion stroke, or during the exhaust stroke so as to exhaust for consumption by, for example, a catalytic converter. In one embodiment, the gaseous fuel could be delivered to the one or more combustion chambers of the engine by actuation of a corresponding delivery injector at near or during a specific point or stage of the piston timing cycle. In another embodiment, the gaseous fuel could be delivered to the one or more combustion chambers of the engine by actuation of a corresponding delivery injector substantially during a specific point or stage of the piston timing cycle.

In some embodiments, a further fuel delivery/injection means could be arranged so as to be specifically associated with the cylinder (for example, by way of a specific fuel injection port arranged in fluid communication with the containment zone when formed) or with one or more existing fuel delivery injectors (for example, a further dispersal port arranged specifically to become operative for the purpose of expunging gaseous fuel therefrom at engine shutdown or start up).

It will be appreciated that any of the above described embodiments, and any described below, may be arranged in accordance with any componentry standard in the art for use with fuel delivery systems for internal combustions engines, such as for example: sensor units, lock off valves, appropriate filter and regulator units. The skilled reader will readily appreciate that each of these components would be standard inclusions for most fuel delivery systems for internal combustion engines. For example, sensor units might be one or more of any types of sensors suitable for informing an electronic controller of real time characteristics of the gaseous fuel source and/or gaseous fuel flow therefrom, including but not limited to pressure, flow, and/or temperature data; lock off valves could be provided in the form of any known valve suitable for selectively closing off supply of gaseous fuel to the fuel rail assembly (for example, for safety/regulatory requirements); appropriate filter units may be provided in the form of a standard filter unit to ensure sufficient integrity of the gaseous fuel supplied from the gaseous fuel source; one or more regulator units may be provided in the form of standard gaseous fuel regulator units to monitor/regulate the flow of gaseous fuel to the fuel rail assembly. All such components can be arranged in-circuit between the gaseous fuel source and the fuel rail assembly. The skilled reader would readily appreciate that each of the components could be arranged as required for any circumstance and still be configurable to work with the embodiments of the invention described herein.

The skilled reader will also appreciate that any of the engine components could be arranged so as to be monitored for control/management purposes by an appropriate means, such for example an electronic control unit (ECU). Thus, each component could be arranged to send appropriate data/communication signals back to the ECU for processing as appropriate. Such processing could result in one or more signals being transmitted from the ECU for initiating a relevant action to be carried out, such action may include one which results in operation of one or more components so monitored in accordance with prescribed process contained in the ECU. It will be appreciated that receipt/transmission of the data/communication signals could be by way of hard-wire or wireless data transmission, or a combination of both.

In one example arrangement having a single fuel rail unit providing gaseous fuel to four fuel delivery injectors, volumetric capacities for rail, fuel delivery injector and overall system volume are in the order of the following respectively: 43,752 mm³ (note: without delivery injector volume included), 2,165 mm³, and 52,411 mm³ (including four delivery injectors).

Any of the above described features may be incorporated with any embodiments of the following principal aspects.

According to a third principal aspect of the present invention, there is provided a fuel rail assembly for direct injection of a gaseous fuel into an internal combustion engine, the fuel rail assembly comprising:

a fuel rail defining a flow passage to receive gaseous fuel;

a plurality of delivery injectors for directly injecting fuel received from the fuel rail into combustion chambers of the engine, the delivery injectors each having a selectively openable delivery port for delivery of gaseous fuel into the respective combustion chamber when the delivery port is in an open condition;

a valve operable to interrupt the flow of gaseous fuel along the flow passage to the delivery injector for delivery into the combustion chamber;

wherein a containment zone is defined between the valve and the various delivery ports when the delivery ports are in a closed condition, the containment zone being selected to be a prescribed volume.

According to a fourth principal aspect of the present invention, there is provided a fuel rail assembly for direct injection of a gaseous fuel into an internal combustion engine, the fuel rail assembly comprising:

a fuel rail defining a flow passage to receive gaseous fuel;

a delivery injector for directly injecting fuel received from the fuel rail into a combustion chamber of the engine, the delivery injector having a selectively openable delivery port for delivery of gaseous fuel into the combustion chamber when the delivery port is in an open condition;

a valve operable to interrupt the flow of gaseous fuel from the flow passage to the delivery injector for delivery into the combustion chamber;

wherein a containment zone is defined between the valve and the delivery port when the delivery port is in a closed condition, the containment zone being selected to be a prescribed volume.

According to a fifth principal aspect of the present invention, there is provided a fuel rail assembly for direct injection of a gaseous fuel into an internal combustion engine, the fuel rail assembly comprising:

a fuel rail defining a flow passage to receive gaseous fuel;

a plurality of delivery injectors for directly injecting fuel received from the fuel rail into combustion chambers of the engine, the delivery injectors each having a selectively openable delivery port for delivery of gaseous fuel into the combustion chamber when the delivery port is in an open condition;

a valve operable to interrupt the flow of gaseous fuel from the flow passage to the delivery injectors for delivery into the combustion chamber;

wherein a distinct volume is defined between each valve and the respective delivery port when the delivery port is in a closed condition, and wherein there is a containment zone comprising the various distinct volumes, the containment zone being selected to be a prescribed volume.

According to a sixth principal aspect of the present invention, there is provided a fuel rail assembly for direct injection of a gaseous fuel into an internal combustion engine, the fuel rail assembly comprising:

a fuel rail defining a flow passage to receive gaseous fuel;

a delivery injector for directly injecting fuel received from the fuel rail into a combustion chamber of the engine, the delivery injector having a selectively openable delivery port for delivery of gaseous fuel into the combustion chamber when the delivery port is in an open condition;

a first valve operable to interrupt the flow of gaseous fuel along the flow passage to the delivery injector, and

a second valve operable to interrupt the flow of gaseous fuel from the flow passage to the delivery injector for delivery into the combustion chamber;

wherein a containment zone is defined within the fuel rail assembly when at least one of the first and second valves is in a closed condition and the delivery port is also in a closed condition, the containment zone being selected to be a prescribed volume.

According to a seventh principal aspect of the present invention, there is provided a fuel rail assembly for direct injection of a gaseous fuel into an internal combustion engine, the fuel rail assembly comprising:

a fuel rail defining a flow passage to receive gaseous fuel;

a plurality of delivery injectors for directly injecting fuel received from the fuel rail into a combustion chamber of the engine, the delivery injectors each having a selectively openable delivery port for delivery of gaseous fuel into the combustion chamber when the delivery port is in an open condition;

a first valve operable to interrupt the flow of gaseous fuel along the flow passage to the delivery injectors, and

a second valve associated with each delivery injector operable to interrupt the flow of gaseous fuel from the flow passage to the respective delivery injector for delivery into the combustion chamber;

wherein a containment zone is defined within the fuel rail assembly when at least either the first valve or each of the second valves is in a closed condition and the delivery ports are each also in a closed condition, the containment zone being selected to be a prescribed volume.

According to an eighth principal aspect of the present invention, there is provided a fuel delivery system for direct injection of fuel into a combustion environment of an internal combustion engine, the fuel delivery system comprising:

a flow passage along which fuel may flow from a fuel source to a dispersal means for administering fuel into the combustion environment; and

a means by which the flow passage can be modified so that a prescribed region of the flow passage extending upstream from the dispersal means can be substantially isolated while the dispersal means ceases to disperse fuel.

According to a ninth principal aspect of the present invention, there is provided a fuel delivery system for direct injection of fuel into a combustion environment of an internal combustion engine, the fuel delivery system comprising:

a flow passage along which fuel may flow from a fuel source to one or more dispersal means, the or each dispersal means arranged for administering fuel into respective combustion environments, each dispersal means fluidly connected with the flow passage, and

a means by which the flow passage can be modified so that a prescribed region of the flow passage extending upstream from the or each dispersal means can be substantially isolated while the dispersal means ceases to disperse fuel.

In one embodiment, the means by which the flow passage is modified is provided in the form of one or more valves arranged in-circuit with the flow passage and operable for modifying the flow of the fuel through the passage. In one arrangement, the or each valve is operable to interrupt the flow of fuel through the passage.

The prescribed region so isolated may comprise a containment zone arranged in accordance with embodiments of the containment zone of the other described principal aspects of the present invention.

In another embodiment, the dispersal means comprises a delivery port of a fuel delivery injector operable for dispersing fuel into the combustion environment.

The combustion environment may comprise a combustion chamber.

In another embodiment, the flow passage is defined by a fuel rail. In such arrangements, the or each fuel delivery injectors are fluidly connected with the fuel rail so as to receive fuel from the flow passage for dispersal into respective combustions chambers.

One of the one or more valves defines a first valve which may be provided substantially upstream of the fuel rail and arranged operable for modifying flow through the flow passage. In one embodiment, the first valve is operable to interrupt the flow of fuel to the fuel rail.

In another arrangement, the first valve may be provided within the fuel rail along the flow passage and operable so as to interrupt flow along the flow passage.

For either of the latter embodiments, a second valve may be provided between the first valve and the dispersal means. In one embodiment, the second valve may be associated with a dispersal means. In another embodiment, the second valve is provided in-circuit between the fuel rail and a respective dispersal means. For the case where the fuel delivery system comprises multiple fuel delivery injectors, a second valve may be provided for each respective fuel delivery injector. In arrangements of this nature, the volumetric capacity of the prescribed region when isolated will depend upon whether the first or second valve is closed.

The flow passage may be configured so that the prescribed region can be placed in fluid communication with a fluid circuit for releasing fuel contained in the prescribed region thereto. In such arrangements, the release of fuel from the prescribed region may serve to reduce the pressure in the prescribed region.

The fluid circuit may be fluidly connected with any one or more of the following: an isolated containment volume, a carbon canister, a catalytic converter, the intake region of the engine, ambient atmosphere, one or more of the combustion chambers of the engine (for injection into the combustion chambers at specific periods during the timing cycle).

In other embodiments, the fluid circuit is arranged in accordance with any of the embodiments of the fluid circuits described above. Thus, it will be understood that the fluid circuit may be arranged having any one of the following provided in-circuit therewith: one or more valves so as to control and/or manage the flow of fuel, one or more isolated containment volumes so that gaseous fuel pressure held in the containment zone can be expanded into the or each volume, one or more carbon canister units for receiving gaseous fuel from the containment zone or prescribed region, one or more catalytic converters, the intake region of the engine, ambient atmosphere, or one or more of the combustion chambers of the engine.

It will be appreciated that embodiments of the fuel delivery system of the eighth and ninth principal aspects may comprise any of the features described in relation to the above described first to seventh principal aspects. Thus, according to another principal aspect of the present invention, there is provided a fuel delivery system for an internal combustion engine operable by direct injection of a gaseous fuel, the fuel delivery system comprising a fuel rail assembly as described herein.

According to a tenth principal aspect of the present invention, there is provided an internal combustion engine operable by direct injection of a gaseous fuel, the engine comprising a fuel rail assembly, fuel delivery system, or fuel system according to any embodiment arranged in accordance with any of the principal aspects of the invention, or any embodiment of a fuel rail assembly, a fuel delivery system, of a fuel system described herein.

According to an eleventh principal aspect of the present invention, there is provided a fuel system for an internal combustion engine operable by direct injection of a gaseous fuel, the fuel system comprising a fuel rail assembly or fuel delivery system according to any embodiment arranged in accordance with any one of the preceding principal aspects of the invention, or any embodiment of a fuel rail assembly or a fuel delivery system described herein.

According to a twelfth principal aspect of the present invention, there is provided a method of operating an internal combustion engine using a fuel system according to the eleventh aspect of the invention.

According to a thirteenth principal aspect of the present invention, there is provided a method of operating an internal combustion engine having a combustion chamber into which gaseous fuel is delivered from a fuel supply by way of a fuel rail assembly comprising a fuel rail and a delivery injector configured to deliver gaseous fuel directly into the combustion chamber, the method comprising:

delivering metered quantities of gaseous fuel to the combustion chamber to satisfy fuelling requirements of the engine, and

terminating supply of fuel to the combustion chamber when operation of the engine is to cease,

wherein a containment zone isolated from the fuel supply is established within the fuel rail assembly upon termination of the supply of fuel to the combustion chamber, the containment zone being of a prescribed volume.

According to a fourteenth principal aspect of the present invention, there is provided a method of operating an internal combustion engine having a plurality of combustion chambers into which gaseous fuel is delivered from a fuel supply by way of a fuel rail assembly comprising a fuel rail and a plurality of delivery injectors configured to deliver gaseous fuel directly into the respective combustion chambers, the method comprising:

delivering metered quantities of gaseous fuel to the combustion chambers to satisfy fuelling requirements of the engine, and

terminating supply of fuel to the combustion chambers when operation of the engine is to cease,

wherein a containment zone isolated from the fuel supply is established within the fuel rail assembly upon termination of the supply of fuel to the combustion chambers, the containment zone being of a prescribed volume.

The method of the thirteenth and fourteenth principal aspects of the invention may further comprise any of the following features.

In one embodiment, the containment zone is configured operable so as to reduce or minimise the quantity of gaseous fuel which could leak into the ambient environment and/or elsewhere in the fuel rail assembly which would otherwise result in unwanted or unacceptable engine emissions.

In another embodiment, the prescribed volume of the containment zone is configured so as to accommodate a known quantity of gaseous fuel which is substantially below acceptable emissions levels.

In a further embodiment, the containment zone is configured so as to assist in the management of potential leakage of gaseous fuel which might be resident in the fuel rail assembly at, near, or following shutdown of the internal combustion engine.

In yet another embodiment, the prescribed volume of the containment zone is configured so as to account for one or more alternate sources of emissions which might emanate from other regions of the internal combustion engine and/or associated vehicle, the prescribed volume of the containment zone being prescribed such that the cumulative effect of any leakage of fuel resident in the containment zone and any emissions which might emanate from the or each alternate sources, would fall below acceptable emissions limits as might be prescribed either by way of legislative standards and/or industry regulations.

In a further embodiment, the containment zone comprises a volumetric capacity configured such that gaseous fuel confined therein is substantially less than a known emissions limit if or when combined with emissions from one or more alternate emissions sources which might be associated with the internal combustion engine and/or associated vehicle.

In another embodiment, the containment zone comprises a volumetric capacity configured such that a difference between the gaseous fuel confined therein and a known emissions limit substantially accounts for known alternate emissions sources.

In a further embodiment, the containment zone comprises a volumetric capacity configured such that a difference between the gaseous fuel confined therein and a predetermined limit accounts for substantially all known alternate emissions sources associated with the internal combustion engine and/or associated vehicle, wherein the predetermined limit is substantially less than a known emissions limit as might be prescribed by way of legislative and/or industrial regulations.

The method may comprise establishing fluid communication between the containment zone and a fluid circuit such that gaseous fuel present within the containment zone may expand into the fluid circuit. In this manner, once the containment zone has been isolated, the gaseous fuel trapped therein can be released into the fluid circuit so as to reduce gaseous pressure in the containment zone. Arrangements of this nature have the benefit of reducing the quantity of gaseous fuel in the containment zone so as to reduce quantities which might leak through the fuel delivery injectors during the time the engine is shutdown.

The fluid circuit may be provided in fluid association with any one or more of the following: an isolated containment volume, a carbon canister, a catalytic converter, the intake region of the engine, ambient atmosphere, or one or more combustion chambers.

In another embodiment, the method comprises concluding fluid communication between the containment zone and the fluid circuit after at least one of: a predetermined period of time has expired, or fuel pressure in the containment zone has reduced to at or below a predetermined level.

In one arrangement, the fluid circuit is arranged in accordance with any of the embodiments of the fluid circuits described above. Thus, it will be understood that the fluid circuit may be arranged having any one of the following provided in-circuit therewith: one or more valves so as to control and/or manage the flow of passing fuel, one or more isolated containment volumes so that gaseous fuel held in the containment zone can be moved or expanded into the or each volume, one or more carbon canister units for receiving gaseous fuel from the containment zone, one or more catalytic converters, the intake region of the engine, ambient atmosphere, or one or more combustion chambers of the engine. It will be understood that any of the latter can be arranged in any appropriate configuration within the fluid circuit.

It will be understood that the fuel rail assembly of the methods of the thirteenth or fourteenth principal aspects can comprise any embodiment of the fuel rail assembly described herein.

It will also be appreciated that any of the embodiments and/or features of the principal aspects described herein may be configured or adapted so as to be applicable to one or more implementations of the methods of the thirteenth or fourteenth principal aspects described herein, that is with method steps corresponding to functions performed by any one or more features and/or embodiments of the fuel rail assembly, the fuel delivery system, or the fuel system described herein.

According to another principal aspect of the present invention, there is provided a method of operating an internal combustion engine using a fuel rail assembly or a fuel delivery system according to any embodiment arranged in accordance with any of the preceding principal aspects of the invention, or any embodiment of a fuel rail assembly or a fuel delivery system described herein.

According to a further principal aspect, there is provided a method for operably configuring a fuel rail assembly, a fuel delivery system, or a fuel system in a manner in which the fuel rail assembly, fuel delivery system, or fuel system accords substantially with any of the embodiments of a fuel rail assembly, a fuel delivery system, or a fuel system as described herein.

According to another principal aspect, there is provided a method for modifying a fuel rail assembly, a fuel delivery system, or a fuel system in a manner in which the fuel rail assembly, fuel delivery system, or fuel system accords substantially with any of the embodiments of a fuel rail assembly, a fuel delivery system, or a fuel system as described herein.

According to a further principal aspect, there is provided a method for operably configuring an internal combustion engine in a manner allowing it to be operable with a fuel rail assembly, a fuel delivery system, or a fuel system as described herein.

According to yet a further principal aspect, there is provided a method for modifying an internal combustion engine in a manner allowing it to be operable with a fuel rail assembly, a fuel delivery system, or a fuel system as described herein.

As foreshadowed above, the various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

All numerical values in this disclosure are understood as being modified by ‘about’. All singular forms of elements, or any other components described herein are understood to include plural forms thereof and vice versa. References to directional and positional descriptions such as ‘upper’ and ‘lower’ and directions e.g. ‘up’, ‘down’, ‘front’, ‘rear’, ‘upper’, ‘lower’ etc. and related terms are to be interpreted by the skilled reader in the context of the examples described and are not to be interpreted as limiting the invention to the literal interpretation of the term, but instead should be as understood by the skilled addressee.

### BRIEF DESCRIPTION OF THE DRAWINGS

Further features of the present invention are more fully described in the following description of several non-limiting embodiments thereof. This description is included solely for the purposes of exemplifying the present invention, and should not be understood as in any way restricting the broad summary, disclosure or description of the invention as set out above. The description of the embodiments which follows will be made with reference, by way of example, to the accompanying drawings in which:

FIG. 1 shows a schematic of a fuel delivery assembly arranged in accordance with the principles of the present invention;

FIG. 2 shows a schematic arrangement of one embodiment of a fuel rail assembly arranged in accordance with the principles of the present invention;

FIG. 3 shows a schematic arrangement of another embodiment of a fuel rail assembly arranged in accordance with the principles of the present invention;

FIG. 4 shows a schematic arrangement of a further embodiment of a fuel rail assembly arranged in accordance with the embodiment shown in FIG. 2, but for the case of multiple delivery injector units (×4 shown);

FIG. 5 shows a schematic arrangement of the embodiment shown in FIG. 4 as it might be implemented in practice;

FIG. 6 shows a schematic diagram of another embodiment of a fuel rail assembly arranged in accordance with the principles of the present invention;

FIG. 7 shows a schematic diagram of a further embodiment of a fuel rail assembly arranged in accordance with the embodiment shown in FIG. 6, but for the case of multiple fuel delivery injector units (×4 shown);

FIG. 8 shows a schematic diagram of a further embodiment of a fuel rail assembly arranged in accordance with the principles of the present invention;

FIG. 9 shows a schematic diagram of another embodiment of a fuel rail assembly arranged similar to that shown in FIG. 8, but for the case of multiple fuel delivery units (×4 shown);

FIG. 10 shows a schematic diagram of a further embodiment of a rail assembly arranged similar to that shown in FIG. 4, further including a separate containment volume arranged in-circuit with the fuel rail unit;

FIG. 11 shows a schematic diagram of a further embodiment of the fuel rail assembly shown in FIG. 10, but configured so residual gaseous fuel in the fuel rail unit can be vented out of circuit;

FIG. 12 shows a schematic diagram of a further embodiment of the fuel rail assembly similar to that shown in FIG. 11, but configured so that residual gaseous fuel, in the fuel rail unit can be vented into a further containment volume and passed onward to the engine air intake;

FIG. 13 shows a schematic diagram of a further embodiment of the fuel rail assembly similar to that shown in FIG. 12, but configured so that residual gaseous fuel in the fuel rail unit can be vented to a carbon canister and, subsequently, passed onward to the engine air intake;

FIG. 14 shows a schematic diagram of a further embodiment of a fuel rail assembly arranged in accordance with the principles of the present invention in which the fuel rail unit and each delivery injector unit can be separately isolated from the gaseous fuel source; and

FIG. 15 shows a graphical representation of possible points in the timing cycle of a piston where gaseous fuel could be injected.

It will be understood that the principal aspects of the present invention are not to be limited in scope by any of the specific embodiments described herein. These embodiments are intended for the purpose of exemplification only. Functionally equivalent products, formulations and methods are clearly within the scope of the invention as described herein.

In the drawings, like structures are referred to by like numerals throughout the several views. The drawings shown are not necessarily to scale, with emphasis instead generally being placed upon illustrating the principles of the present invention.

### DESCRIPTION OF EMBODIMENTS

Various embodiments of a fuel rail assembly for use with an engine (not shown) are shown throughout the figures. Throughout the embodiments described, the engine will be understood as comprising an internal combustion engine configured for gaseous fuel operation of the direct injection type. The principles of the embodiments of the fuel rail assembly described herein (and shown in the figures) could be readily applied or embodied for use with a fuel delivery system (or, for example, a fuel system).

The term “direct injection” refers to delivery of fuel directly into the combustion chambers of internal combustion engines, typically by way of fuel injectors.

The term “gaseous fuel(s)” as used herein refers to compressed gas fuels such as compressed natural gas (CNG) and hydrogen (H₂), and liquefied gaseous fuels such as liquefied petroleum gas (LPG) and liquefied natural gas (LNG). The skilled reader will appreciate that other appropriate gaseous fuels may also be used, such as for example, natural gas, propane, methane, synthetic gas, landfill gas, coal gas, biogas from agricultural anaerobic digesters, or any other gaseous fuel.

Embodiments of the fuel rail assembly and associated methods described herein may include one or more range of values (e.g. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

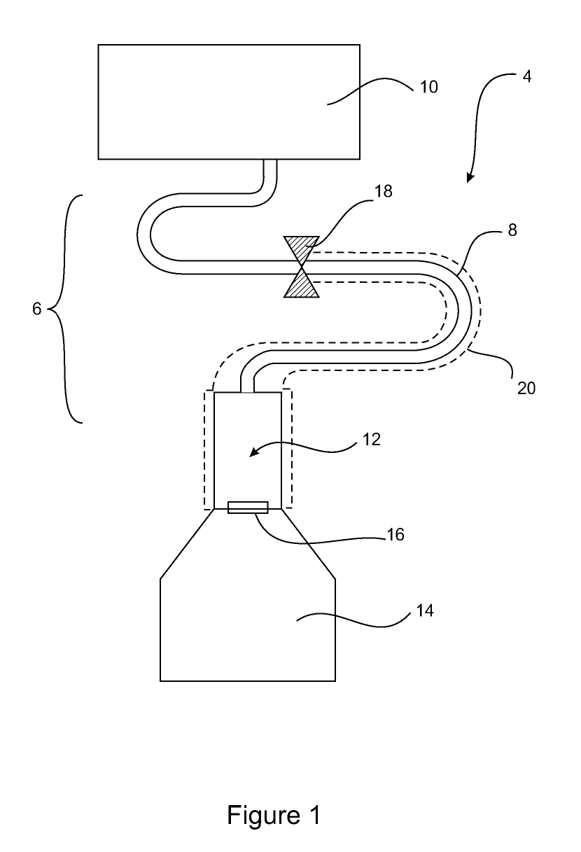

FIG. 1 schematically shows one arrangement 4 of a fuel rail assembly which can be implemented for direct injection of a gaseous fuel into an internal combustion engine. The arrangement 4 provides a flow passage 8 arranged for receiving gaseous fuel from a source of gaseous fuel 10 for delivery to a fuel delivery injector 12 for directly injecting fuel received from a fuel rail (referenced, generally, by numeral 6) into a combustion environment (provided in the form of a combustion chamber 14) of the engine. The fuel delivery injector 12 comprises a selectively openable delivery port 16 for the delivery of gaseous fuel into the combustion chamber 14 when the delivery port 16 is in an open condition. A valve 18 is provided in-circuit between the gaseous fuel source 10 and the delivery port 16 (for example, within flow passage 8) and arranged operable so as to interrupt the flow of gaseous fuel to delivery port 16 for delivery into the combustion chamber 14. A containment zone 20 is selected so that a prescribed volume is defined between the valve 18 and the delivery port 16 when the delivery port is in a closed condition.

The arrangement 4 shown in FIG. 1 may provide, in another implementation, a fuel delivery arrangement in which flow passage 8 is arranged such that fuel may flow therethrough from the gaseous fuel source 10 to delivery port 16 for admission into the combustion chamber 14. Valve 18 provides a means by which the flow passage 8 can be modified so that a prescribed region of the flow passage extending upstream from the delivery port 16 can be substantially isolated (i.e. forming the containment zone 20).

The parameters or specifications which premise the design of the arrangement 4 of the fuel rail assembly may be informed so as to acknowledge a tolerable amount of leakage, and the prescribed volume of the containment zone is set according to the maximum amount of leakage deemed to be tolerable. The tolerable amount may be determined according to various design parameters to which regard may be had during design of the fuel rail assembly, including, for example, the extent of leakage which may be tolerable without adversely affecting performance requirements for the engine at start-up, and/or the extent of leakage which is tolerable without adversely affecting prescribed environmental emission standards for operation of the engine.

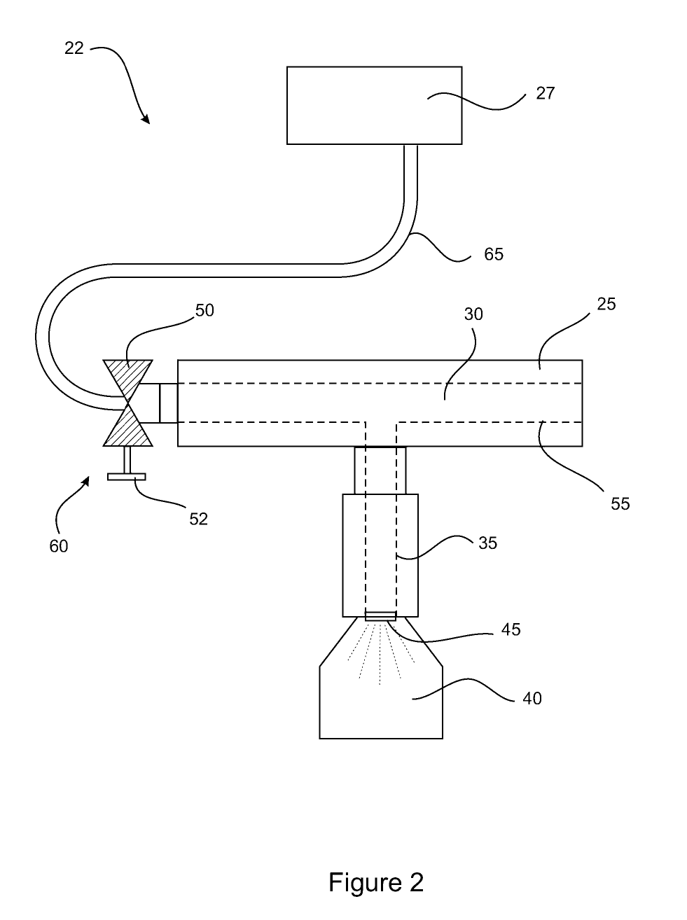

FIG. 2 shows an embodiment of a fuel rail assembly 22 arranged for direct injection of gaseous fuel into an internal combustion engine. The fuel rail assembly 22 comprises a fuel rail unit 25 which defines a flow passage 30 configured for receiving gaseous fuel from a gaseous fuel source 27. A fuel delivery injector 35 is provided for directly injecting gaseous fuel received from the fuel rail 25 into a combustion chamber 40 of the engine. The fuel delivery injector 35 is arranged having a selectively openable delivery port 45 for delivery of gaseous fuel into the combustion chamber 40 when the delivery port is in an open condition.

A valve 50 is provided in-circuit between the fuel source 27 and the delivery injector 35 and arranged operable (by way of valve actuating means 52) so as to interrupt the flow of gaseous fuel to the delivery injector 35 for delivery into the combustion chamber 40. The valve 50 is arranged within the fuel rail assembly 22 so that a containment zone 55 is defined between the valve 50 and the delivery port 45 (when in a closed condition). The containment zone 55 is arranged having a prescribed volume which is informed by one or more parameters to ensure leakage from the containment zone is less than the prescribed emission levels. In this manner, assuming or accepting that the delivery port 45 is susceptible to a degree of leakage therethrough, any residual gaseous fuel resident within the containment zone 55 at the time the valve 50 is closed represents the maximum quantity available to leak through the delivery port 45 and into the combustion chamber 40.

The arrangement of the fuel rail assembly 22 shown in FIG. 2 allows direct management of the amount of the gaseous fuel that can potentially leak through into the combustion chamber 40 while the engine is shutdown. As shown in FIG. 2, valve 50 is associated with the fuel rail unit 25 so as to control the flow of gaseous fuel along the flow passage 30 to the delivery injector unit 35. For the arrangement shown, the valve 50 is located at or near an inlet end 60 of the fuel rail unit 25. The inlet end 60 is arranged so as to receive a conduit 65 for establishing fluid communication between the gaseous fuel source 27 and the fuel rail unit 25 such that fuel may be received therein.

The valve 50 may be associated with the fuel rail unit 25 in any appropriate way. For example, in other arrangements, the valve 50 could be provided upstream of the inlet end 60 or could be located within the fuel rail unit 25 itself downstream of the inlet end 60. Placement of the valve 50 will depend on desired system volume.

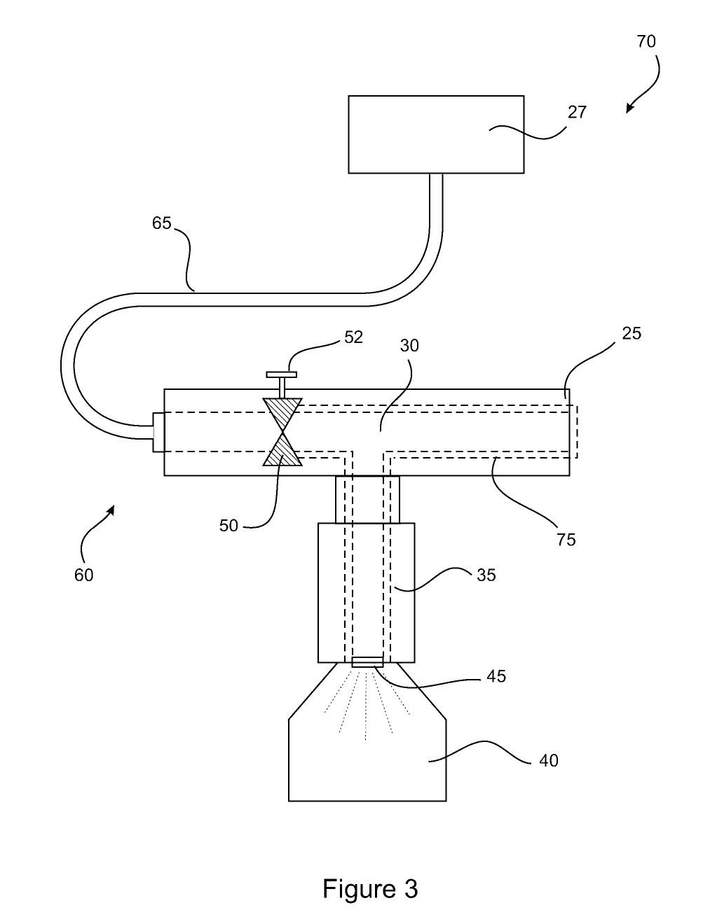

FIG. 3 shows an embodiment of a fuel rail assembly 70 which reflects a variation of the fuel rail assembly 22 shown in FIG. 2. Although both fuel rail assemblies 22 and 70 are similar in overall configuration, the latter is arranged having the valve 50 provided along the flow passage 30 upstream of the delivery port 45 of the fuel delivery injector 35 and downstream of the inlet end 60 of the fuel rail unit 25. In this arrangement, a containment zone 75 is defined between the valve 50 and delivery port 45 when the port is closed. As the skilled reader will readily appreciate, as a consequence of the placement of the valve 50 relative to the delivery port 45, the volumetric capacity of containment zones 55 and 75 can be varied or prescribed as might be required for a specified circumstance and/or emissions levels.

The respective volumetric capacities of containment zones 55 and 75 in the embodiments shown in FIGS. 2 and 3 are prescribed according to parameters or specifications considered acceptable for engine performance and/or acceptable emission limits as noted previously.

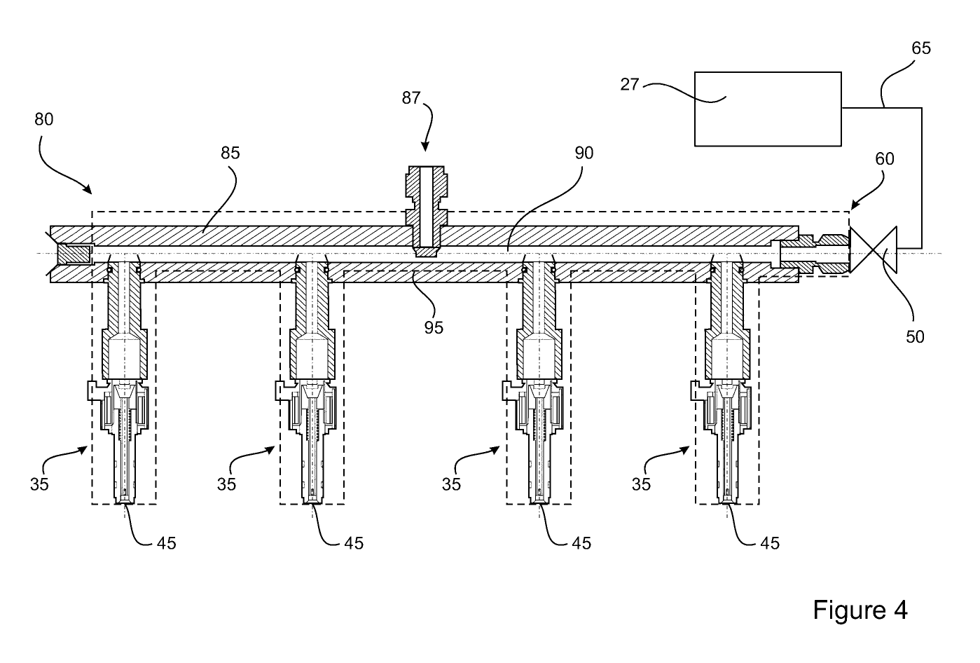

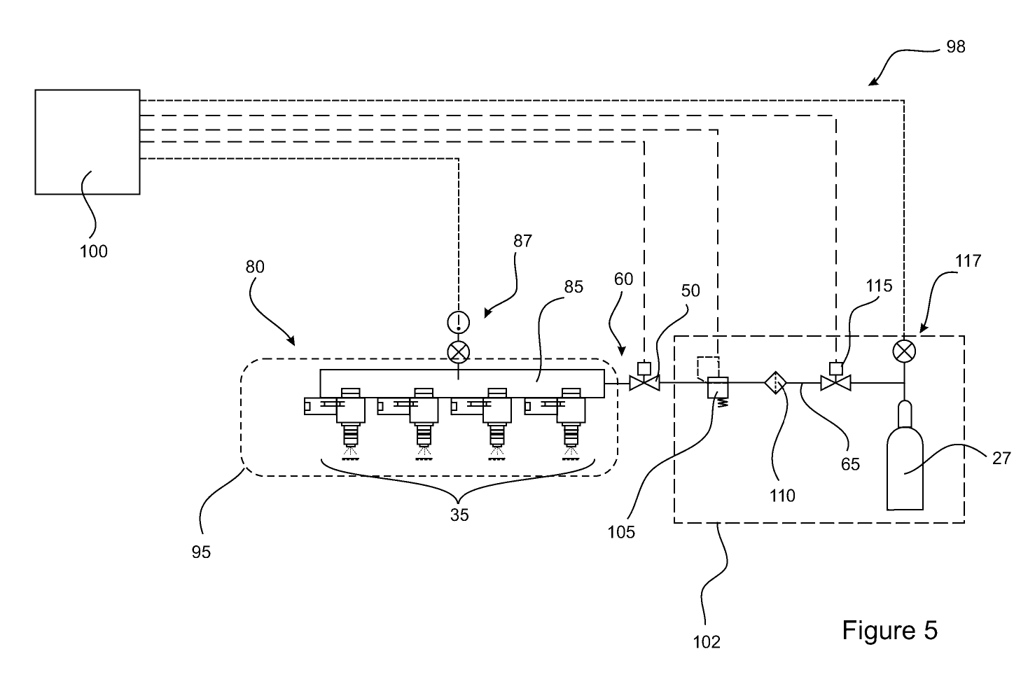

FIGS. 4 and 5 both show embodiments of a fuel rail assembly 80 having a fuel rail unit 85 configured to receive gaseous fuel from gaseous fuel source 27 for provision to multiple fuel delivery injectors 35 (four delivery injectors are shown). In this arrangement, integration of the fuel rail unit 85 with the four fuel delivery injectors 35 serves to define a flow passage 90 through which gaseous fuel received from the gaseous fuel source 27 may flow by way of conduit 65. The fuel rail unit 85 is also configured so as to accommodate one or more sensor assemblies 87 which might be desirous for monitoring one or more parameters necessary for controlling/managing engine performance. Such sensors will be well known by persons skilled in the art, and may include, for example, temperature, pressure and/or flow rate sensors.

Consistent with the arrangements shown in FIG. 2 and FIG. 3, valve 50 is provided at inlet end 60 of the fuel rail unit 85 such that the flow of gaseous fuel to each fuel delivery injector 35 can be interrupted when the valve 50 is closed. In this arrangement, when valve 50 is closed, a containment zone 95 is defined. Accordingly, the volumetric capacity of the containment zone 95 is prescribed such that leakage, if any, through one or more delivery ports 45 of respective delivery injectors 35 into associated combustion chambers (not shown) is in accordance with quantities considered to be acceptable (i.e. below or within prescribed emissions limits).

FIG. 5 shows a revised system arrangement 98 which extends the arrangement of the fuel rail assembly 80 shown in FIG. 4 to include operable association with a controller 100 which can be provided, for example, in the form of, or as part of, the engine's electronic control unit (ECU). In the arrangement shown in FIG. 5, conduit 65 is arranged to fluidly connect gaseous fuel source 27 to valve 50, and is arranged to also include a number of components (group of components 102), which include, in series, regulator unit 105, filter 110, lock off valve 115, and sensor assembly 117, all of which provide feedback to controller 100 for control/management purposes. Thus, in this configuration, controller 100 can be tasked with active monitoring and control of the operation and performance of the fuel rail assembly 80.

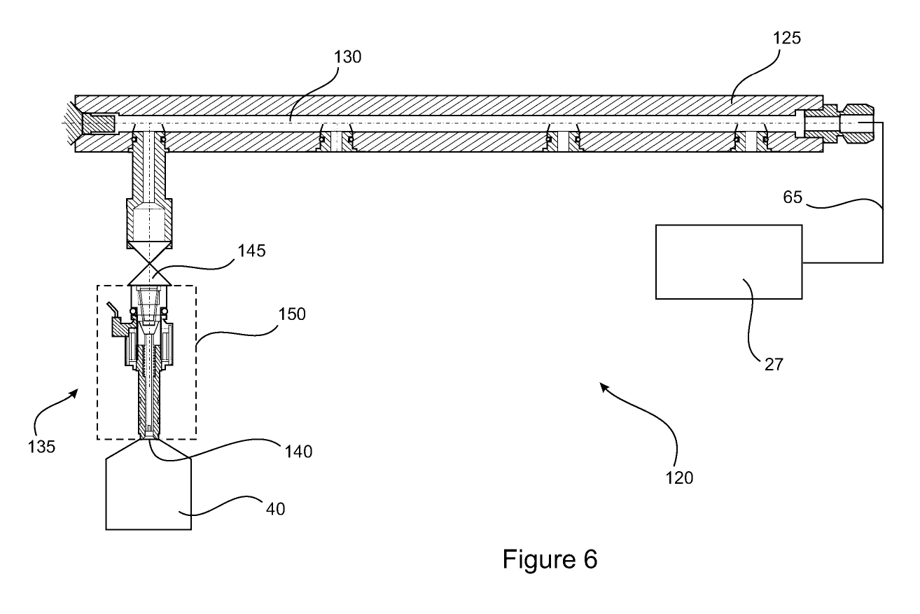

FIG. 6 shows an embodiment of a fuel rail assembly 120 arranged according to the principles of the present invention. The fuel rail assembly 120 comprises a fuel rail unit 125 defining a flow passage 130 for receiving gaseous fuel from gaseous fuel source 27 by way of conduit 65. A single delivery injector 135 is provided for directly injecting fuel received from the fuel rail unit 125 into combustion chamber 40 by way of a selectively openable delivery port 140 when in an open condition. In the embodiment shown, a valve 145 is provided with fuel rail unit 125 so as to be operable to interrupt the flow of gaseous fuel from the flow passage 130 to the delivery injector 135. Thus, the arrangement is configured such that a containment zone 150 (having a prescribed volume) is defined between the valve 145 (when closed) and the delivery port 140 when closed.

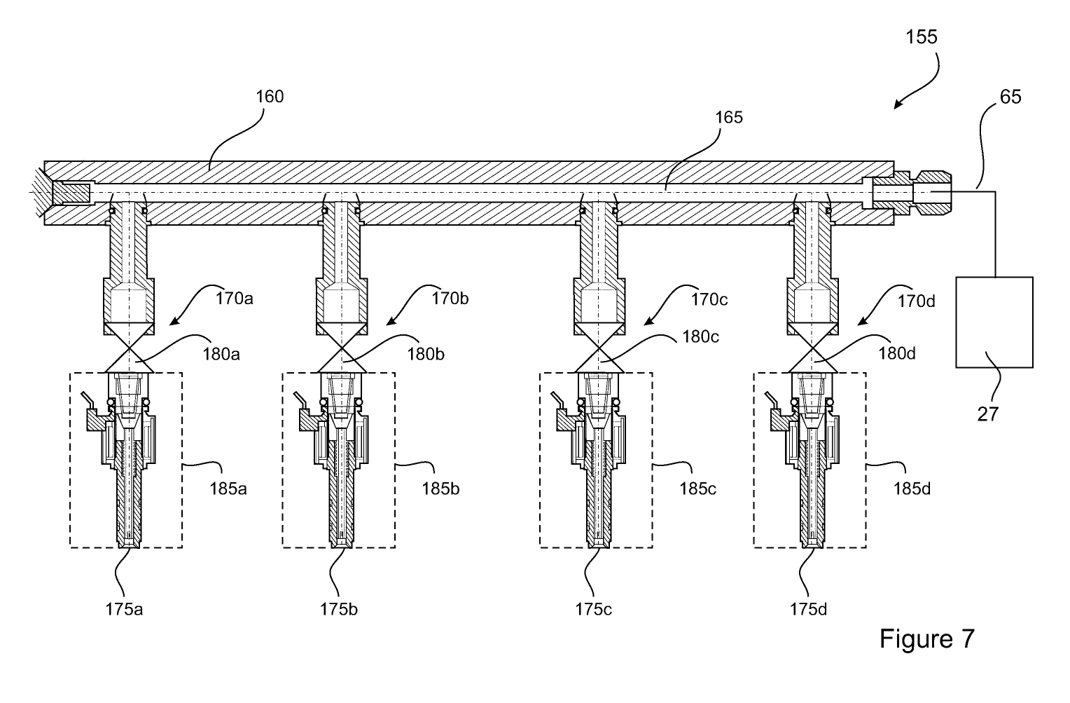

Another embodiment of a fuel rail assembly 155 arranged in accordance with the principles of the present invention is shown in FIG. 7. Fuel rail assembly 155 comprises a fuel rail unit 160 defining a flow passage 165 for receiving gaseous fuel from gaseous fuel source 27 by way of conduit 65. Four delivery injectors 170a, 170b, 170c, and 170d (collectively, 170ₙ), are provided for directly injecting gaseous fuel received from the fuel rail unit 160 into respective combustion chambers (not shown) by way of respective selectively openable delivery ports 175a, 175b, 175c, and 175d (collectively, 175ₙ), when in an open condition. Each delivery injector 170ₙ is provided with a respective valve 180a, 180b, 180c, and 180d (collectively, 180ₙ) and arranged operable so as to interrupt the flow of gaseous fuel from the flow passage 165 to each delivery injector (170ₙ). The arrangement is configured such that the closing of each valve (180ₙ) defines respective containment zones 185a, 185b, 185c, and 185d (collectively 185ₙ), between the valves and respective delivery ports 175ₙ. Each containment zone 185ₙ is configured so as to have a prescribed volumetric capacity. Thus, for embodiments where there are pluralities of delivery injectors each having a respective one of the valves, the effective containment zone may comprise the accumulation of the plurality of distinct volumes (i.e. containment zones 185ₙ) each, as described, corresponding to the volume between a respective one of the valves (180ₙ) and the delivery port (175ₙ) of the respective delivery injector (170ₙ).

It will be appreciated that an embodiment along the lines of that shown in FIG. 7 as compared to the embodiment shown in FIG. 4 will facilitate the provision of a smaller containment zone for the fuel rail assembly (i.e. the containment zone 185ₙ associated with each delivery injector 170ₙ in FIG. 7 is considerably smaller than the containment zone 95 shown in FIG. 4). Providing a containment zone having a smaller volume (i.e. typically one where each delivery injector 170ₙ is provided with a respective valve 180ₙ) can help ensure that any gaseous fuel contained in the containment zone is considerably less than a prescribed vapour emissions target. Furthermore, providing a smaller containment zone along the lines indicated above can additionally reduce the effect of any gaseous fuel which may leak from the delivery injector on engine starting reliability or on the engine emissions upon engine starting.

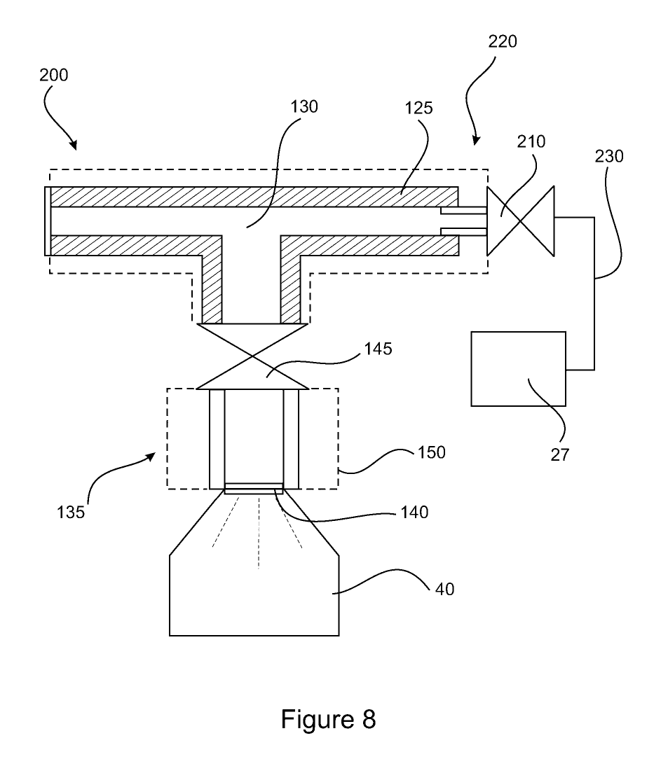

FIG. 8 shows an embodiment of a fuel rail assembly 200 comprising a fuel rail unit 125 defining a flow passage 130 for receiving gaseous fuel from fuel source 27 by way of inlet fuel passage 230. The fuel rail assembly 200 comprises a single delivery injector 135 for directly injecting gaseous fuel received from the fuel rail unit 125 into combustion chamber 40 by way of a selectively openable delivery port 140 when in an open condition. A valve 145 is provided and arranged operable so as to interrupt the flow of gaseous fuel from the flow passage 130 to the delivery injector 135 for delivery into the combustion chamber 40. The arrangement is configured such that a containment zone comprising region 150 having a prescribed volume is defined between the valve 145 and the delivery port 140 when both are closed.

The fuel rail assembly 200 also comprises a valve 210 provided at an inlet end 220 of the fuel rail unit 125. The valve 210 is arranged so as to be operable for interrupting a flow of gaseous fuel from the flow passage 230 to the delivery injector 135. A containment zone is defined within the fuel rail assembly 200 when either at least valve 210 or valve 145 is closed and the delivery port 140 is also in a closed condition. In accordance with the prior embodiments described, the containment zone, when so formed, is of a prescribed volumetric capacity

With reference to FIG. 8, it will be understood that closing valve 210 and leaving valve 145 open, provides a containment zone which includes region 130 and region 150. The effect of closing valve 145 serves to provide a containment zone which comprises substantially region 150. Similarly, the containment zone, when so formed, is of a prescribed volumetric capacity.

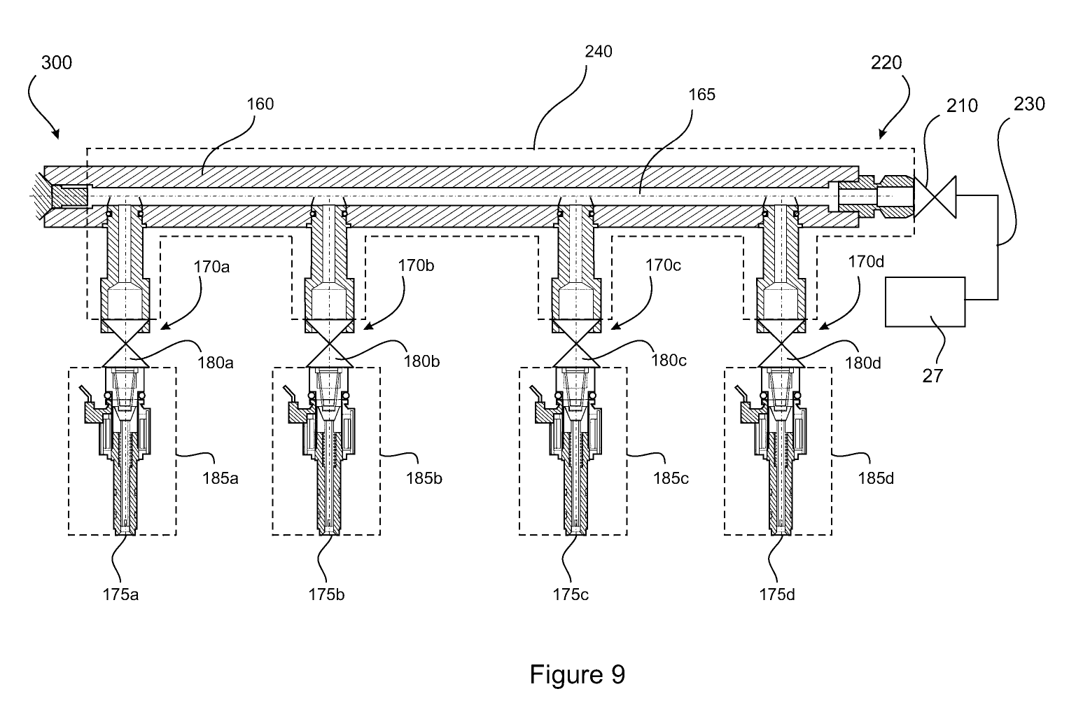

FIG. 9 shows an embodiment a fuel rail assembly (embodiment 300) which is configured substantially similar to that shown in FIG. 8, but for the case of multiple fuel delivery injector units (4x shown). The fuel rail assembly 300 is similar in arrangement to that shown in FIG. 7 but includes valve 210 provided intermediate inlet end 220 of the fuel rail unit 160 and the fuel source 27 by way of conduit 230. Valves 180ₙ are provided in delivery injectors 170ₙ (see the embodiment shown in FIG. 7) and arranged operable to interrupt the flow of gaseous fuel along the flow passage 165 to respective delivery ports 175ₙ. Valve 210 is arranged operable to interrupt the flow of gaseous fuel received from the fuel source 27 to delivery injectors 170ₙ. A containment zone is defined within the fuel rail assembly 300 when either at least valve 210 or each of valves 180ₙ are closed and the respective delivery ports 175ₙ are also in a closed condition.

In accordance with the prior embodiments, it will be understood that closing valve 210 and leaving each of valves 180ₙ open provides a containment zone which includes region 240 and each of regions 185ₙ (which represents an effective ‘system’ volume). Further, the effect of closing each of valves 180ₙ serves to provide a containment zone comprising a respective region 185ₙ. Thus, in each instance, the containment zone, when so formed, is of a prescribed volume so that a quantity of gas resident in the zone at the time of engine shutdown, if leaked therefrom, is of a quantity less than or within acceptable levels.

It will be understood that, at least in one aspect, incorporation of valve 210 offers a level of redundancy in the event any of valves 185 for whatever reason fail. In such instances, the volumetric capacity of the containment zone, when so formed, is prescribed so as to ensure that the quantity of gas resident therein at the time valve 210 is closed is less than acceptable limits should gas leak through one or more of valves 185ₙ.

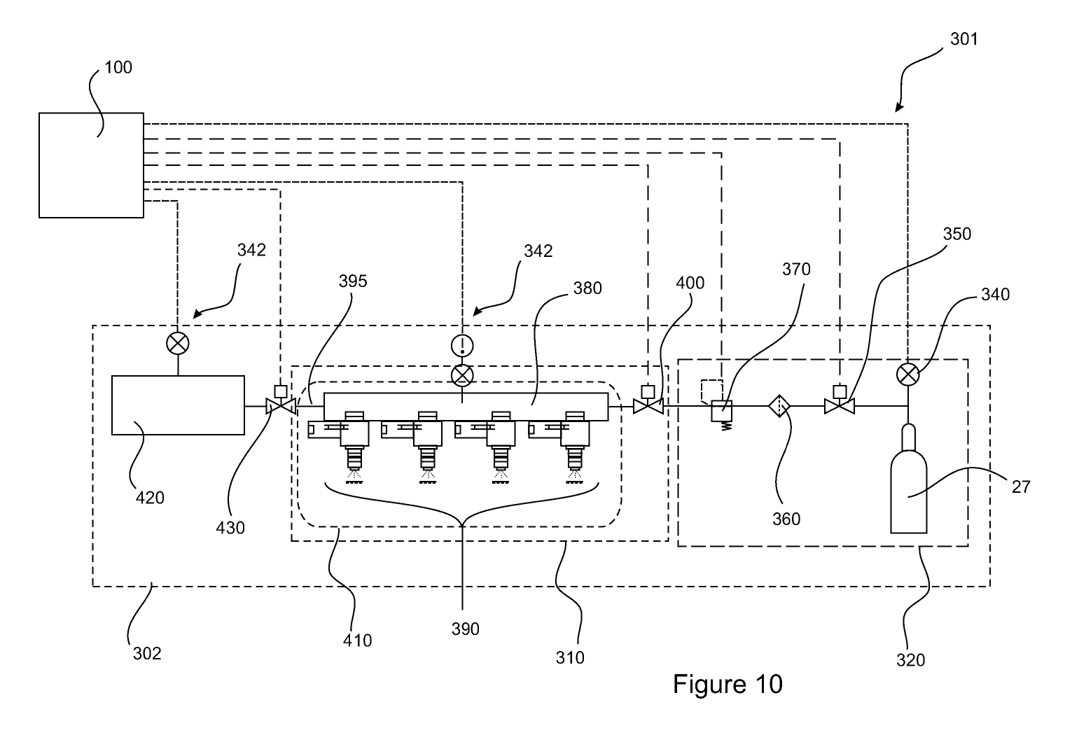

FIG. 10 shows an embodiment of a system 301 which serves to exemplify one arrangement of a fuel delivery system 302 (which could be arranged as a fuel system or part of a fuel system) which incorporates a fuel rail assembly 310 arranged in accordance with the principles of the present invention. The system 301 includes a group 320 of componentry standard of such systems and a controller 100 tasked with managing the overall operation of the constituents in the system.

The group 320 of components includes, but may not be limited to, sensor 340, lock off valve 350, filter 360, and regulator 370. The skilled reader will readily appreciate that each of the components in group 320 would be standard inclusions for any fuel delivery system for an internal combustion engine: sensor 340 could be one or more of any types of sensors suitable for informing controller 100 of real time characteristics of the fuel source 27 and/or fuel flow therefrom, including but not limited to pressure, flow, and/or temperature data; lock off valve 350 could be provided in the form of any known valve suitable for selectively closing off the supply of fuel to the fuel rail assembly 310 (i.e. for safety/regulatory requirements); filter 360 may be provided in the form of a standard filter unit to ensure sufficient integrity of the fuel supplied from the fuel source 27; regulator 370 may be provided in the form of a standard fuel regulator unit to monitor the flow of fuel to the fuel rail assembly 310. For the embodiment shown, all components 340, 350, 360 and 370 are arranged in circuit between the fuel source 27 and the fuel rail assembly 310. The skilled reader would readily appreciate that each of the components could be arranged as required for any circumstance and still be configurable to work with the embodiments of the invention described herein.

As would be well understood by the skilled reader, operation of the gaseous fuel delivery injectors in a standard internal combustion engine is controlled by an electronic control unit (ECU). The ECU can control the operating parameters of each fuel injector, particularly the duration of the opening of the delivery port of the delivery injector, as well as the points in the engine cycle at which the delivery port of the injector is opened and closed. For the arrangement shown in FIG. 10, the controller 100 can be provided as or part of an engine's ECU. Thus, it will be understood that the controller 100 can be arranged so as to monitor the operation of any of the core componentry in the system 301 as any circumstance may require.

The fuel rail assembly 310 is arranged substantially similar to the fuel rail assembly 80 shown in FIG. 4, with fuel rail unit 380 arranged for receiving gaseous fuel from gaseous fuel source 27 and delivering said fuel to respective combustion chambers (not shown) by way of fuel delivery injectors 390. A valve 400 is provided in-circuit between the gaseous fuel source 27 and the respective delivery ports of the fuel delivery injectors 390 and arranged operable so as to interrupt the flow of fuel to delivery ports for delivery into the respective combustion chambers. A containment zone (410) is defined so that a prescribed volume is defined between the valve 400 and the respective delivery ports of the fuel injectors 390 when the ports are in a closed condition.

The fuel rail unit 380 is provided with sensors 342 so that operation of the fuel rail unit/assembly can be actively monitored by controller 100. As noted above in relation to sensor 340, sensors 342 could be one or more of any types of sensors suitable for informing controller 100 of real time characteristics of the fuel flow through the fuel rail unit, fuel flow therefrom, including but not limited to pressure, flow rate, and/or temperature data.

The fuel delivery system 302 also includes a further volume 420 which is arranged in selective fluid association with the fuel rail unit 380 by way of a first fluid circuit 395 and valve 430 provided in-circuit therewith. For the case of a gaseous fuel, further volume 420 is provided so as to provide a means of allowing rapid changes in pressure in the fuel rail unit to occur when transitioning between high and low engine operating loads. For example, when the engine is operating at high working load (which equates to higher pressure in the fuel rail unit), a rapid transition to a low operating pressure (in which a low operating pressure in the fuel rail is to be reached, preferably in a relatively short time period) can be achieved by opening valve 430 to allow gaseous fuel to exit from the fuel rail unit 380 into the volume 420. Thus, by increasing the available volume in the system upstream of the fuel delivery injectors 390, the gaseous fuel pressure in the fuel rail unit 380 can be reduced much quicker, rather than waiting for pressure in the fuel rail to abate during the course of normal operation of the engine.

The further volume 420 can be arranged having one or more sensors 342 such that the volume can be actively monitored by the controller 100. As discussed above, sensor 342 could be one or more of any types of sensors suitable for informing controller 100 of real time characteristics of the volume 420, including but not limited to internal pressure, flow rate, and/or internal temperature.

The presence of volume 420 can also be used to enhance operation of the fuel rail assembly 310 in a similar manner when seeking to reduce residual amounts of gaseous fuel resident in the containment zone at or near shut-down of the engine. For example, when shutdown is initiated, valve 400 is closed thereby interrupting (and indeed terminating) supply of gaseous fuel to the fuel rail unit 380. At this time, with valve 430 closed, the gas supply available to the fuel delivery injectors is limited to the volume downstream of valve 400 (but upstream of the delivery ports of the delivery injectors) so defining the containment zone. The pressure within the containment zone in the fuel rail unit 380 can be reduced further by opening valve 430 and therefore access to the volume 420. Once valve 430 is opened, gaseous fuel resident in the containment zone in the fuel rail unit 380 can expand into volume 420 thereby reducing gaseous fuel pressure in the fuel rail unit. At an appropriate time, valve 430 can be closed and the fuel injectors 390 subject to a more limited amount of gaseous fuel, the levels of which are less or within prescribed emissions limits if leakage into the respective combustion chambers were to occur.

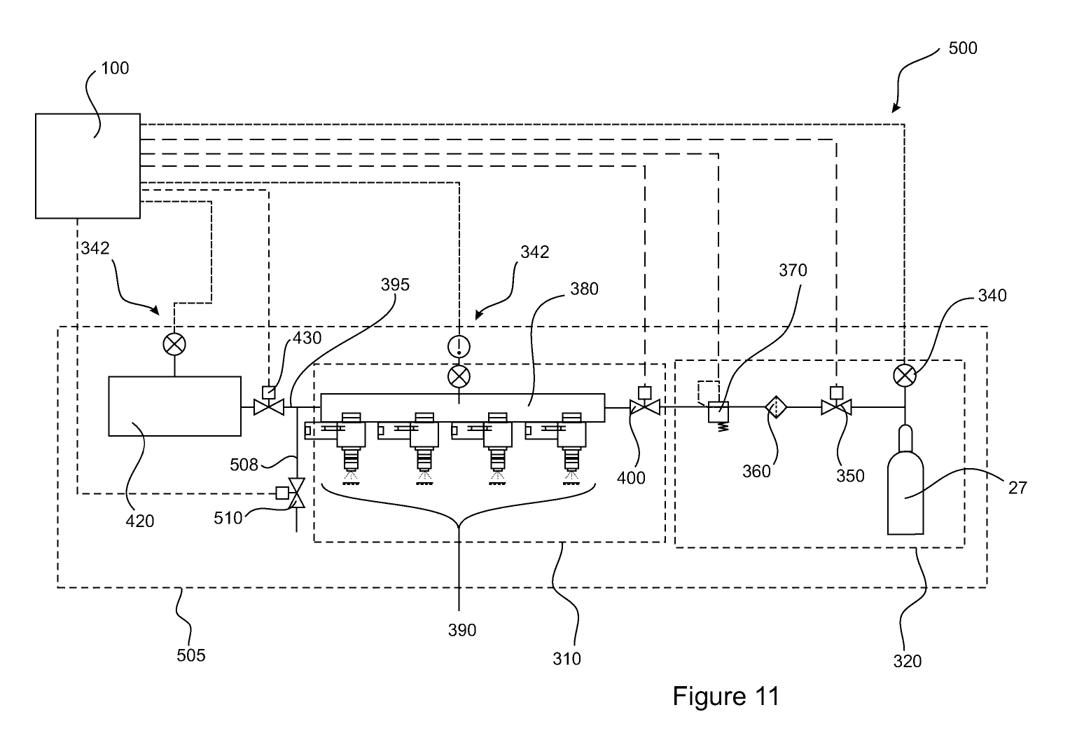

FIG. 11 shows an embodiment of a system 500 which reflects a minor variation of the arrangement shown in FIG. 10. In substance, system 500 includes a fuel rail delivery system 505 which, while retaining the same fuel rail assembly 310 shown in FIG. 10, includes a second fluid circuit 508 (provided in the form of an appropriate conduit arrangement or similar) provided downstream of the fuel rail unit 380. In the embodiment shown, the second fluid circuit 508 is fluidly connected with the first fluid circuit 395, but upstream of valve 430. The second fluid circuit 508 includes an additional valve 510 provided in-circuit therewith.

Operation of the system 500 at shutdown is substantially the same as that noted above, however, reduction of the pressure in the fuel rail unit 380 can be achieved by opening valve 510 to increase the available volume into which residual gaseous fuel in the containment zone in the fuel rail unit 380 can expand into. Valve 510 can be arranged to vent residual gas into any desirous atmosphere in order to reduce gaseous pressure in the containment zone in the fuel rail unit 380. For example, valve 510 could be arranged to vent gaseous fuel into any convenient region of the engine (such as for example the engine's intake system or one or more of the engine's combustion chambers), or to simply vent to the ambient surrounds (such as the atmosphere).

In operation, when operating at low load requirements, for example, when engine shutdown is commenced, valve 400 can be closed thereby terminating the supply of gaseous fuel to the fuel rail unit 380, and therefore limiting the supply of fuel to fuel delivery injectors 390 to that contained in the volume in the fuel rail unit 380 downstream of the valve 400 (assuming valve 430 is closed). Thus, rather than opening valve 430, as what might occur in a high working load mode, valve 510 can be opened and arranged to vent to a pressure environment that might be, for example, lower than that which would be available if valve 430 were opened. Accordingly, when seeking to reduce the gaseous pressure in the fuel rail unit 380 when operating in, for example, a low load mode, provision of valve 510 can serve as an effective means to reduce the residual amounts of gaseous fuel trapped in the fuel rail unit 380 when valve 400 is closed.

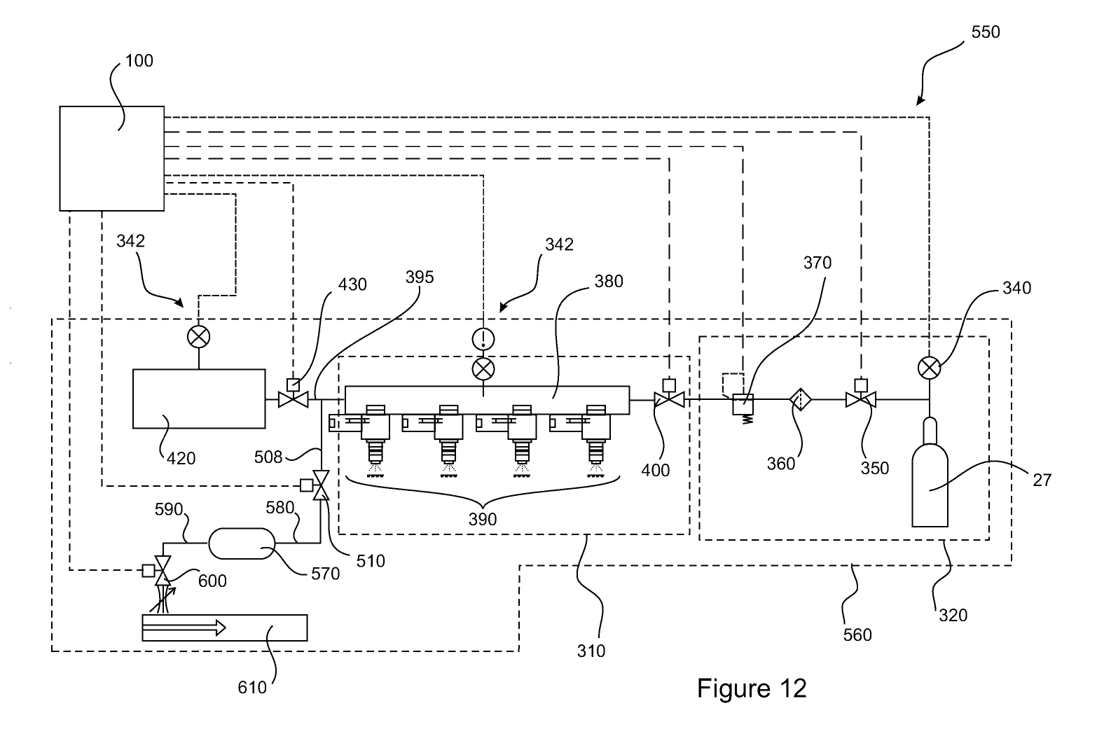

A variation of the arrangement shown in FIG. 11 is shown in FIG. 12. In this regard, system 550 retains many of the features shown inherent in system 500. However, valve 510 is arranged having a number of additional components provided in-circuit downstream thereof. Particularly, the second fluid circuit 508 is provided with a further volume 570 which is fluidly connected with valve 510. Additionally, downstream of volume 570, and fluidly connected thereto by way of fluid conduits 580, 590, is a non-return valve 600. Non-return valve 600 is arranged so as to be operated by controller 100 so that it can be selectively opened and closed. It will be appreciated that a standard valve suitable for releasing and inhibiting flow would also be suitable in place of non-return valve 600.

With valve 430 closed, valve 510 is arranged to vent gaseous fuel trapped in the containment zone in the fuel rail unit 380 at shutdown into the volume 570 by way of second fluid circuit 508. Non-return valve 600 is arranged to fluidly connect with the air intake region of the engine 610 by an appropriate conduit assembly (not shown). In operation, like that with the arrangement shown in FIG. 11, valve 510 can be selectively operated by the controller 100 to vent gaseous fuel trapped in the fuel rail unit 380 when valve 400 is closed so as to reduce potential gaseous emissions to levels substantially less than acceptable limits.

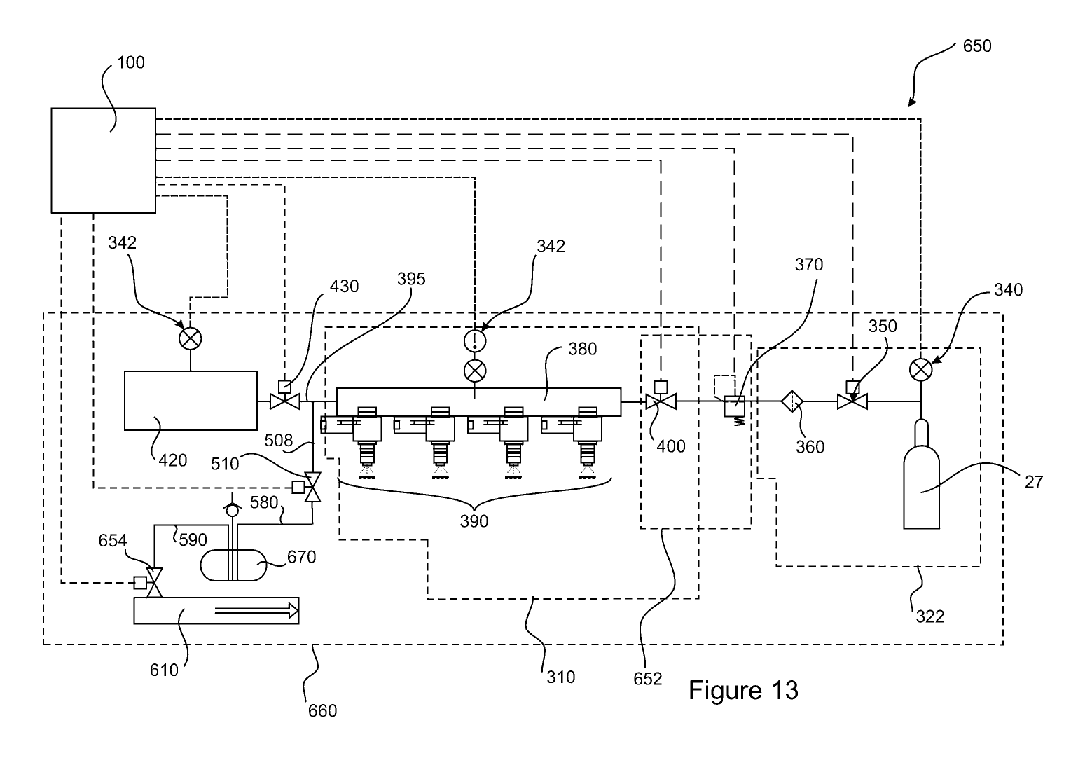

FIG. 13 shows a further variation to the above, showing a system 650 in which a fuel delivery system 660 replaces volume 570 with a filter unit provided in the form of a carbon canister 670. The skilled reader will understand the general structure and operation of a carbon canister, the details of which are beyond the scope of this description. In this arrangement, opening of valve 510 allows gaseous fuel to pass to carbon canister 670 for containment. The gaseous fuel will remain trapped in the carbon canister 670 until engine start up at which time the sudden suction created along the engine's intake manifold opens valve 654 and pulls all the gaseous fuel out of the canister 670 for consumption by the engine during operation.

A further revision to system 650 can be seen in that the valve 400 and the regulator 370 are provided as a single unit 652. As a consequence of this, sensor assembly 340, lock off valve 350 and fuel regulator 370 are provided as a component group 322.

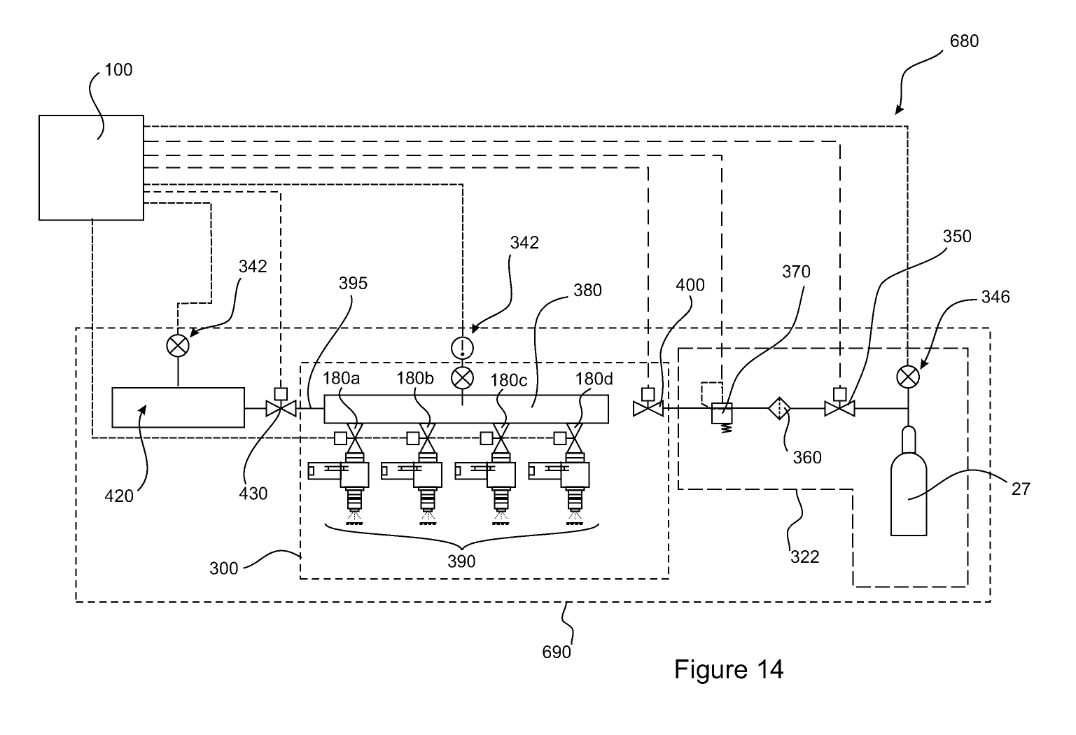

FIG. 14 shows a system 680 which represents a variation on the system arrangement 301 shown in FIG. 10. However, the arrangement 680 differs by inclusion of the fuel rail assembly 300 shown in FIG. 9. As shown, while valve 400 isolates the fuel rail unit 380 from the fuel source 27, valves 180(a-d) are provided in respective fuel injectors 390 so as to isolate their delivery flow paths downstream thereof when their respective delivery ports are closed.

The skilled reader will appreciate that the fuel rail assembly 300, as shown in the arrangement presented in FIG. 14, could be readily substituted in place of or in favour of the fuel rail assembly 310 shown in the embodiments of the fuel delivery system shown in FIG. 11 to FIG. 13.

Expunging of gaseous fuel from the containment zone on engine shutdown or start up could also be achieved by reconfiguring the fuel delivery injectors to disperse gaseous fuel directly into the combustion chamber at certain stages during the piston timing cycle. Arrangements of this nature could be developed with or without the use of upstream valves arranged to specifically isolate the containment zone.

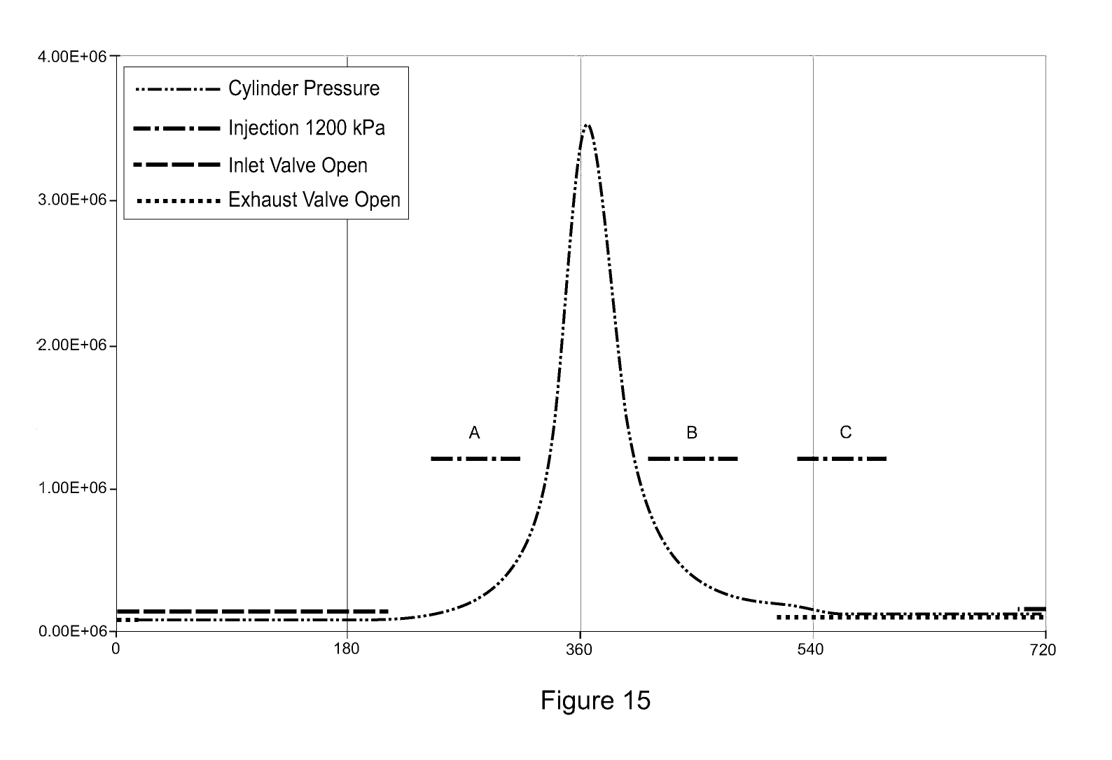

FIG. 15 shows a number of possible stages during the timing cycle where gaseous fuel from the containment zone could be introduced into an engine cylinder, namely: (A) injection during the compression stroke once the inlet valve has been opened; (B) injection during expansion stroke (during which time some or all of the injected fuel will be consumed); or (C) injection during the exhaust stroke so as to vent the gaseous fuel into the exhaust (while open) while an exhaust system catalytic converter remains active.

It is worth noting that some of the above described timing options may be used to combust or oxidise the gas that is delivered with no resulting engine power to effectively allow the gas to be ‘vented’ at times of low demand for engine power such as shutdown or engine idle. For example, this is particularly true where the injection of the gaseous fuel from the containment zone occurs during an exhaust stroke or during an expansion stroke.

It will be appreciated that a further specific fuel delivery/injection means associated with the cylinder (e.g. by way of a specific fuel injection port arranged in fluid communication with the containment zone) or with the existing fuel delivery injector (e.g. a further dispersal port arranged specifically to become operative for the purpose of expunging gaseous pressure therefrom at engine shutdown or start up), could be arranged to become operable once the containment zone becomes formed.

In view of the above, it will be appreciated that the volumetric capacity of the containment zone can be arranged so as to account for one or more alternate known sources of hydrocarbon emissions which might emanate from other component parts of the engine. Thus, the volumetric capacity of the containment may be prescribed such that the cumulative effect of any leakage of gaseous fuel trapped in the containment zone and any emissions which might emanate from one or more alternate sources, would fall below acceptable emissions limits as might be prescribed (either by way of legislative standards and/or industry regulations).

Alternate sources of emissions could comprise any one or more of the following: various plastics and/or rubbers which might permeate or emit gaseous vapour, and various glues and paints which are known to contribute to hydrocarbon emissions. It will be appreciated that other components of an engine (or an associated vehicle) could also be responsible for emission levels the subject of legislative and/or industrial regulations.

The volumetric capacity of the prescribed volume may therefore be configured such that a difference between the gaseous fuel confined therein and a predetermined limit substantially accounts for known alternate emissions sources whereby the predetermined limit is substantially less than any prescribed emissions limit. In such arrangements, the predetermined limit, at least in part, may serve as a design standard to ensure that known sources of hydrocarbon emissions coexisting in an engine to which the fuel rail/delivery system is to be installed are accounted for when prescribing the volumetric capacity of the containment zone. For example, the predetermined limit could be set or defined as a nominated amount which is less than the known prescribed emissions limit, such as for example, a percentage of the emissions limit, or another associated variable which serves to quantify a level of tolerance. Thus, the difference between the known emissions limit and the predetermined limit could reflect a margin of tolerance ensuring that, should gaseous fuel contained in the containment zone leak through the delivery port of one or more fuel delivery injectors, there will be sufficient confidence that emissions levels will be less than prescribed levels when also considering and accounting for known alternate emissions sources.

As noted above, existing emissions are around 2 g carbon equivalent. A prototype fuel rail assembly system has been developed and tested incorporating a single fuel rail unit having provision for feeding gaseous fuel to four fuel delivery injectors (for use in a direct injection internal combustion engine). The volumetric capacities for fuel rail, fuel delivery injector and overall system volume is around the following respectively: 43,752 mm³ (note: without delivery injector volume included), 2,165 mm³, and 52,411 mm³. This configuration has been found to meet acceptable engine performance criteria. The following hydrocarbon levels were calculated for three example pressure levels:

| Pressure (kPa g) | Rail (mg) | Delivery injector (mg) | System (mg) |
|---|---|---|---|
| 0 | 28 | 1 | 34 |
| 1,000 | 312 | 15 | 373 |
| 2,000 | 595 | 29 | 713 |

Thus, for a system pressure of 1,000 kPa, the quantity of hydrocarbon levels (methane in this example) residing in the rail, delivery injector, and system volumes respectively is 312 mg, 15 mg, and 373 mg (i.e. accounting for four delivery injectors). In this example, it is noted that the estimated quantities in the system are well below the 2 g limit noted above. This example system has been developed to account for alternate sources of hydrocarbon emissions so ensuring that any emissions from all known emission sources are below prescribed limits. Thus, this system has been designed to include an acceptable margin of tolerance which accounts for alternate emission sources.

By way of comparison with the prototype arrangement, the following table of data shows approximate prescribed system volumes as a function of pressure and the corresponding mass of carbon or carbon equivalent (of methane gas).

| Contained gas (g) | Pressure (kPa g) | Volume (mm³) | Volume (l) |
|---|---|---|---|
| 1 | 1000 | 223,777 | 0.22 |
| 1 | 2000 | 117,217 | 0.12 |
| 1 | 3000 | 79,405 | 0.08 |
| 2 | 1000 | 447,555 | 0.45 |
| 2 | 2000 | 234,433 | 0.23 |
| 2 | 3000 | 158,810 | 0.16 |

At 2,000 kPa and 25 degrees Celsius, the volume of the fuel rail and delivery injectors should be less than 234,433 mm³=0.23 litres to contain less than 2 g methane. At 1,000 kPa and 25 degrees Celsius, the volume of the fuel rail and delivery injectors should be less than 447,555 mm³=0.45 litres to contain less than 2 g methane. As discussed above, given the possibility for vapour emissions contribution from other sources, a smaller volume of the system can be selected to reduce potential contribution from the fuel system to 50% of 2 g (=1 g).

The above described embodiments can be operated in a broad sense as follows.

An operative method using any of the above described fuel rail assembly or fuel system embodiments may first involve delivering metered quantities of gaseous fuel to the combustion chamber to satisfy fuelling requirements of the engine. When operation of the engine is to cease, such supply of fuel to the combustion chamber is terminated so establishing, within the fuel rail assembly, a containment zone, of a prescribed volume, which is isolated from the fuel supply upon termination. As is clear from the above description, the prescribed volume of the containment zone, when so formed, is to ensure that any quantity of resident gas, if allowed to or expected to leak, is less than acceptable levels.

Operation of any of the embodiments described may include establishing fluid communication between the containment zone and a fluid flow circuit (such as the first (395) or second (508) fluid circuit described above) such that gaseous fuel present within the containment zone may move or expand into the fluid circuit. In this manner, once the containment zone has been isolated, the gaseous fuel trapped therein can be released or expanded into the fluid flow circuit so as to reduce gaseous pressure in the containment zone.

The fluid circuits may be arranged having any one of the following provided in-circuit therewith: one or more valves so as to control and/or manage the flow of passing fuel, one or more isolated containments volumes so that gaseous fuel pressure held in the containment zone can be moved or expand into, one or more carbon canister units for receiving gaseous fuel from the containment zone, one or more catalytic converters, the intake region of the engine, one or more combustion chambers, or ambient atmosphere.

The skilled reader will appreciate that various methods can be developed and implemented for operating an internal combustion engine using embodiments of the fuel rail assembly, fuel delivery system, and fuel system described herein. Furthermore, methods can be developed and implemented for operably configuring a fuel rail assembly, a fuel delivery system, or a fuel system in a manner whereby the resulting fuel rail assembly, fuel delivery system, or fuel system accords substantially with any of the embodiments described herein.

Various methods can also be developed and implemented which serve to modify an existing fuel rail assembly, a fuel delivery system, or a fuel system in a manner in which the fuel rail assembly, fuel delivery system, or fuel system accords substantially with any of the embodiments described herein.

In addition, various methods could be developed and implemented which serve to operably configure an internal combustion engine in a manner allowing it to be operable with a fuel rail assembly, a fuel delivery system, or a fuel system as described herein. Furthermore, methods can be developed and implemented for modifying an existing internal combustion engine in a manner allowing it to be operable with a fuel rail assembly, a fuel delivery system, or a fuel system as described herein.

It will also be appreciated that any of the embodiments and/or features described herein may be configured or adapted so as to be applicable to one or more implementations of the methods described herein, that is with method steps corresponding to functions performed by any one or more features and/or embodiments of the fuel rail assembly, the fuel delivery system, or the fuel system described herein.

While the present invention has been described in terms of preferred embodiments in order to facilitate better understanding of the invention, those skilled in the art will appreciate that various modifications can be made without departing from the principles of the invention. The principal aspects of the inventions described herein includes, in respective embodiments, all such variations and modifications within its scope. The invention also includes all of the steps, and features, referred to or indicated in the specification, individually or collectively and any and all combinations or any two or more of the steps or features.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

1. A fuel rail assembly for direct injection of a gaseous fuel into an internal combustion engine, the fuel rail assembly comprising:
a fuel rail defining a flow passage for receiving gaseous fuel;
a delivery injector for directly injecting fuel received from the fuel rail into a combustion chamber of the engine, the delivery injector having a selectively openable delivery port for delivery of gaseous fuel into the combustion chamber when the delivery port is in an open condition; and
a valve operable so as to interrupt the flow of gaseous fuel to the delivery injector for delivery into the combustion chamber;
wherein a containment zone is defined between the valve and the delivery port when the delivery port is in a closed condition, the containment zone being selected to be a prescribed volume,
and wherein the prescribed volume of the containment zone is configured so as to accommodate a known quantity of gaseous fuel which is substantially below acceptable emissions levels.

2. (canceled)

3. The fuel rail assembly according to claim 1, wherein the containment zone is configured operable so as to reduce or minimise the quantity of gaseous fuel which could leak into the ambient environment and/or elsewhere in the fuel rail assembly which would otherwise result in unwanted or unacceptable engine emissions.

4. (canceled)

5. (canceled)

6. The fuel rail assembly according to claim 1, wherein the prescribed volume of the containment zone is configured so as to accommodate a known quantity of gaseous fuel which is substantially below acceptable emissions levels at, near, or following engine shutdown.

7. The fuel rail assembly according to claim 1, wherein the prescribed volume of the containment zone is configured so as to account for one or more alternate sources of emissions which might emanate from other regions of the internal combustion engine and/or associated vehicle, the prescribed volume of the containment zone being prescribed such that the cumulative effect of any leakage of fuel resident in the containment zone and any emissions which might emanate from the or each alternate sources would fall below acceptable emissions limits as might be prescribed either by way of legislative standards and/or industry regulations.

8. The fuel rail assembly according to claim 1, wherein the containment zone comprises a volumetric capacity configured such that gaseous fuel confined therein is substantially less than a known emissions limit if or when combined with emissions from one or more alternate emissions sources which might be associated with the internal combustion engine and/or associated vehicle.

9. (canceled)

10. (canceled)

11. The fuel rail assembly according to claim 1, wherein the valve is associated with the fuel rail so as to control fuel flow along the flow passage to the delivery injector.

12. The fuel rail assembly according to claim 1, wherein the valve is located:
(i) at or near an inlet end of the fuel rail; or
(ii) upstream of an inlet end of the fuel rail; or
(iii) within the fuel rail downstream of an inlet end.

13. The fuel rail assembly according to claim 1, wherein the valve is associated with the delivery injector to control fuel flow from the flow passage to the delivery injector.

14. The fuel rail assembly according to claim 1, wherein the valve is incorporated in a branch line extending between the fuel rail to the delivery injector.

15.-17. (canceled)

18. The fuel rail assembly according to claim 1, wherein the internal combustion engine comprises a multi-cylinder engine, and the delivery injector comprises one of a plurality of delivery injectors for the internal combustion engine.

19. The fuel rail assembly according to claim 18, wherein each of the plurality of delivery injectors has a respective valve associated therewith.

20. The fuel rail assembly according to claim 1, wherein the prescribed volume corresponds to the maximum amount of gaseous fuel which is deemed to be acceptable to leak through the delivery injector(s) into the combustion chamber(s) when the delivery port, or each of the delivery ports, is in the closed condition.

21. The fuel rail assembly according to claim 1, wherein the valve is associated with the fuel rail, and the containment zone comprises the volume downstream of the valve.

22. The fuel rail assembly according to claim 21, wherein the downstream volume comprises the volume within the fuel rail downstream of the valve together with the volume associated with the fuel injector, or each of the fuel injectors, upstream of the respective delivery port(s).

23. The fuel rail assembly according to claim 19, wherein for the case where the delivery injectors each have a respective one of the valves, the containment zone comprises the accumulation of a plurality of distinct volumes each corresponding to the volume between a respective one of the valves and the delivery port of the respective delivery injector.

24. The fuel rail assembly according to claim 1, wherein the fuel rail comprises an outlet through which fuel can exit or exhaust from the flow passage.

25. The fuel rail assembly according to claim 24, wherein one or more fluid circuits are fluidly connected to the outlet such that gaseous fuel in the flow passage in the fuel rail may flow through and into the or each fluid circuit.

26. The fuel rail assembly according to claim 24, wherein the flow passage is configured so that the containment zone can be placed in fluid communication, via the outlet of the fuel rail, with a first fluid circuit for releasing fuel contained in the containment zone.

27. The fuel rail assembly according to claim 26, wherein a flow control valve is provided at any point in-circuit with the first fluid circuit so that the flow of gaseous fuel through or along the first fluid circuit can be controlled in a substantially selective manner.

28. The fuel rail assembly according to claim 27, wherein the first fluid circuit is fluidly connected with a first volume provided downstream of the flow control valve of the first fluid circuit, whereby gaseous fuel from the flow passage of the fuel rail can be permitted to flow into the first volume when the flow control valve is open.

29. The fuel rail assembly according to claim 26, wherein the flow control valve of the first fluid circuit is configured so as to be capable of venting directly to atmosphere or to a means for trapping emissions for later consumption by the engine.

30. (canceled)

31. The fuel rail assembly according to claim 24, wherein a second fluid circuit may be fluidly connected to the first fluid circuit, the second fluid circuit being arranged in fluid communication with any point along the first fluid circuit upstream of the flow control valve of the first fluid circuit and downstream of the outlet of the fuel rail.

32. The fuel rail assembly according to claim 31, wherein a flow control valve may be provided in-circuit with the second fluid circuit, the flow control valve of the second fluid circuit being configured so as to be capable of venting directly to atmosphere or a means for trapping emissions for later consumption by the engine.

33. The fuel rail assembly according to claim 31, wherein a second volume is fluidly connected with the second fluid circuit, the second volume being fluidly connected with the second fluid circuit downstream of the flow control valve of the second fluid circuit such that the flow of gaseous fuel through the second fluid circuit can be selectively directed into the second volume.

34. The fuel rail assembly according to claim 32, wherein the second fluid circuit is provided with a second flow control valve arranged in-circuit therewith, the second flow control valve of the second fluid circuit arranged so as to be fluidly connected with the engine's air intake.

35. The fuel rail assembly according to claim 34, wherein the second volume within the second fluid circuit is provided in the form of a means for trapping or containing hydrocarbon emissions such that the trapped or contained matter can be conveyed back for consumption by the engine.

36. (canceled)

37. The fuel system for an internal combustion engine operable by direct injection of a gaseous fuel, the fuel system comprising a fuel rail assembly according to claim 1.

38. An internal combustion engine operable by direct injection of a gaseous fuel, the engine comprising a fuel rail assembly according to claim 1.

39. (canceled)

40. A method of operating an internal combustion engine having a combustion chamber into which gaseous fuel is delivered from a fuel supply by way of a fuel rail assembly comprising a fuel rail and a delivery injector configured to deliver gaseous fuel directly into the combustion chamber, the method comprising:
delivering metered quantities of gaseous fuel to the combustion chamber to satisfy fuelling requirements of the engine, and
terminating supply of fuel to the combustion chamber when operation of the engine is to cease,
wherein a containment zone isolated from the fuel supply is established within the fuel rail assembly upon termination of the supply of fuel to the combustion chamber, the containment zone being of a prescribed volume, the prescribed volume of the containment zone is configured so as to accommodate a known quantity of gaseous fuel which is substantially below acceptable emissions levels.

41.-44. (canceled)

45. The method according to claim 40, wherein the prescribed volume of the containment zone is configured so as to account for one or more alternate sources of emissions which might emanate from other regions of the internal combustion engine and/or associated vehicle, the prescribed volume of the containment zone being prescribed such that the cumulative effect of any leakage of fuel resident in the containment zone and any emissions which might emanate from the or each alternate sources, would fall below acceptable emissions limits as might be prescribed either by way of legislative standards and/or industry regulations.

46. The method according to claim 40, wherein the containment zone comprises a volumetric capacity configured such that gaseous fuel confined therein is substantially less than a known emissions limit if or when combined with emissions from one or more alternate emissions sources which might be associated with the internal combustion engine and/or associated vehicle.

47. (canceled)

48. (canceled)

49. The method according to claim 40, wherein the method comprises establishing fluid communication between the containment zone and a fluid circuit such that gaseous fuel present within the containment zone is expandable into the fluid circuit so as to reduce gaseous pressure in the containment zone.

50. (canceled)

51. The method according to claim 49, wherein the method further comprises concluding fluid communication between the containment zone and the fluid circuit after at least one of: a predetermined period of time has expired, or fuel pressure in the containment zone has reduced to at or below a predetermined level.

52. (canceled)

53. An internal combustion engine operable by direct injection of a gaseous fuel, the engine comprising a fuel system according to claim 37.
